(19) United States
(12) Patent Application Publication
(10) Pub. No.: US 2009/0279840 A1
(43) Pub. Date: Nov. 12, 2009

(54) Image Digesting Apparatus

(76) Inventors: Daiki Kudo, Tokyo (JP); Hirofumi Nishikawa, Tokyo (JP); Yoshiaki Kato, Tokyo (JP)

Correspondence Address: BIRCH STEWART KOLASCH & BIRCH, PO BOX 747, FALLS CHURCH, VA, 22040-0747, US

(21) Appl. No.: 11/991,604

(22) PCT Filed: Jun. 23, 2006
(86) PCT No.: PCT/JP2006/312634

§ 371 Date: Mar. 7, 2008

(30) Foreign Application Priority Data
Oct. 27, 2005 (JP) 2005-313228

(51) Int. Cl. H04N 5/93

(52) U.S. Cl. 386/52

(57) ABSTRACT

There is provided a shot length calculating unit 2 for, when a result of determination by a cut point determination part 16 in a cut point detecting unit 1 shows that a frame is a cut point, calculating the shot length of a shot starting from a cut point immediately preceding the cut point. Whether or not the shot starting from the cut point immediately preceding the cut point is an important shot is determined with the shot length calculated by the shot length calculating unit 2 being used as a criterion of the determination.

### FIELD OF THE INVENTION

The present invention relates to an image digesting apparatus which can extract an image in an important section from an image signal, and which can carry out a playback or editing of the image in the important section.

### BACKGROUND OF THE INVENTION

There has been proposed an image digesting apparatus which divides an image signal into parts in units of a shot by detecting cut points of the image and which discriminates an important shot from among a plurality of shots.

As disclosed in the following nonpatent reference 1, the process of discriminating an important shot from among a plurality of shots is carried out by using a very complicated method, such as one of a variety of image processing methods and sound processing methods, and it is therefore difficult to carry out discrimination of an important shot in real time and to incorporate the process into mobile equipment.

When editing or playing back a shot which is actually categorized into a group is performed, a list of small images which is called a thumbnail is used in many cases.

In many cases, a representative image of each shot is used for this thumbnail, and an image of the head of each shot is used as the representative image.

However, the head image of a shot is not necessarily an image showing the shot typically. Therefore, even if the user looks at a list of thumbnails, he or she may be unable to identify where a shot which he or she desires to watch and listen to is.

[Nonpatent reference 1] “Video Summarization Based on the Psychological Unfolding of a Drama”, the Institute of Electronics, Information and Communication Engineers paper magazine, D-II, Vol. J84-D-II, No. 6, pp. 1122 to 1131, 2001, written by Tsuyoshi Moriyama and Masao Sakauchi.

Because the conventional image digesting apparatus is constructed as mentioned above, the conventional image digesting apparatus cannot discriminate an important shot from among a plurality of shots unless it uses a very complicated method, such as one of a variety of image processing methods and sound processing methods, and it is therefore difficult for the conventional image digesting apparatus to carry out discrimination of an important shot in real time and to incorporate such a method into mobile equipment.

Another problem is that because the head image of a shot is not necessarily an image showing the shot typically, the user may be unable to identify where a shot which he or she desires to watch and listen to is even if he or she looks at a list of thumbnails.

The present invention is made in order to solve the above-mentioned problems, and it is therefore an object of the present invention to provide an image digesting apparatus which enables the user to grasp an important shot easily without carrying out any complicated processing and without increasing the calculation load.

### DISCLOSURE OF THE INVENTION

An image digesting apparatus in accordance with the present invention includes a shot length calculating means for, when a cut point detecting means detects a cut point, calculating the shot length of a shot starting from a cut point immediately preceding the detected cut point, and determines whether or not the shot starting from the cut point immediately preceding the detected cut point is an important shot by using the shot length calculated by the shot length calculating means as a criterion of the determination.

Therefore, the present invention provides an advantage of enabling the user to grasp an important shot easily without carrying out any complicated processing and increasing the calculation load.

### BRIEF DESCRIPTION OF THE FIGURES

FIG. 1 is a block diagram showing an image digesting apparatus in accordance with Embodiment 1 of the present invention;

FIG. 2 is a block diagram showing a cut point detecting unit 1 of the image digesting apparatus in accordance with Embodiment 1 of the present invention;

FIG. 3 is an explanatory drawing showing a change in a brightness value and cut points;

FIG. 4 is a flow chart showing a description of processing carried out by the image digesting apparatus in accordance with Embodiment 1 of the present invention;

FIG. 5 is a block diagram showing an image digesting apparatus in accordance with Embodiment 2 of the present invention;

FIG. 6 is a block diagram showing an image digesting apparatus in accordance with Embodiment 3 of the present invention;

FIG. 7 is an explanatory drawing showing, in a case in which an important shot exists for every divided region into which an image content is divided, a region represented by the shot;

FIG. 8 is a block diagram showing an image digesting apparatus in accordance with Embodiment 4 of the present invention;

FIG. 9 is an explanatory drawing showing a large change point in a content;

FIG. 10 is a block diagram showing an image digesting apparatus in accordance with Embodiment 5 of the present invention;

FIG. 11 is a block diagram showing an image digesting apparatus in accordance with Embodiment 6 of the present invention;

FIG. 12 is a block diagram showing an image digesting apparatus in accordance with Embodiment 7 of the present invention;

FIG. 13 is a block diagram showing an image digesting apparatus in accordance with Embodiment 8 of the present invention;

FIG. 14 is a block diagram showing an image digesting apparatus in accordance with Embodiment 9 of the present invention;

FIG. 15 is a block diagram showing an image digesting apparatus in accordance with Embodiment 10 of the present invention;

FIG. 16 is a block diagram showing an image digesting apparatus in accordance with Embodiment 11 of the present invention;

FIG. 17 is an explanatory drawing showing a log normal distribution of shot lengths;

FIG. 18 is an explanatory drawing showing a relation between a shot length and an image content length;

FIG. 19 is a block diagram showing an image digesting apparatus in accordance with Embodiment 12 of the present invention;

FIG. 20 is a block diagram showing an image digesting apparatus in accordance with Embodiment 13 of the present invention;

FIG. 21 is a block diagram showing an image digesting apparatus in accordance with Embodiment 14 of the present invention;

FIG. 22 is a block diagram showing an image digesting apparatus in accordance with Embodiment 15 of the present invention;

FIG. 23 is a block diagram showing an image digesting apparatus in accordance with Embodiment 16 of the present invention;

FIG. 24 is a block diagram showing an image digesting apparatus in accordance with Embodiment 17 of the present invention;

FIG. 25 is a block diagram showing an image digesting apparatus in accordance with Embodiment 18 of the present invention;

FIG. 26 is a block diagram showing an image digesting apparatus in accordance with Embodiment 19 of the present invention;

FIG. 27 is a block diagram showing an image digesting apparatus in accordance with Embodiment 20 of the present invention;

FIG. 28 is a block diagram showing an AV cut point determination unit 121 of the image digesting apparatus in accordance with Embodiment 20 of the present invention;

FIG. 29 is a block diagram showing an image digesting apparatus in accordance with Embodiment 21 of the present invention;

FIG. 30 is a block diagram showing an image digesting apparatus in accordance with Embodiment 22 of the present invention;

FIG. 31 is a block diagram showing an image digesting apparatus in accordance with Embodiment 23 of the present invention;

FIG. 32 is a block diagram showing an image digesting apparatus in accordance with Embodiment 24 of the present invention;

FIG. 33 is a block diagram showing an image digesting apparatus in accordance with Embodiment 25 of the present invention; and

FIG. 34 is a block diagram showing an image digesting apparatus in accordance with Embodiment 26 of the present invention.

### PREFERRED EMBODIMENTS OF THE INVENTION

Hereafter, in order to explain this invention in greater detail, the preferred embodiments of the present invention will be described with reference to the accompanying drawings.

### Embodiment 1

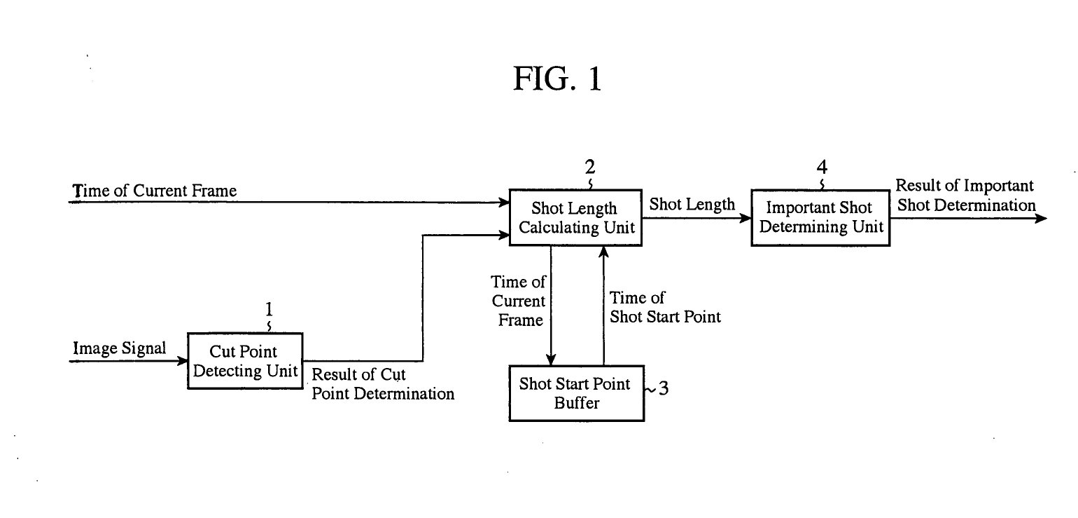

FIG. 1 is a block diagram showing an image digesting apparatus in accordance with Embodiment 1 of the present invention. In the figure, a cut point detecting unit 1 carries out a process of, when receiving an image signal, detecting cut points of the image. The cut point detecting unit 1 constructs a cut point detecting means.

A shot length calculating unit 2 carries out a process of, when a cut point is detected by the cut point detecting unit 1, calculating the shot length of a shot starting from a preceding cut point immediately preceding the cut point (the immediately preceding cut point is the one which was detected the last time by the cut point detecting unit 1). More specifically, when a cut point is detected by the cut point detecting unit 1, the shot length calculating unit carries out a process of calculating a time difference between the time of a current frame and that of a shot start point stored in a shot start point buffer 3, and outputting, as a shot length, the time difference to an important shot determining unit 4. The shot start point buffer 3 is a memory for storing the time of the shot start point.

A shot length calculating means is comprised of the shot length calculating unit 2 and the shot start point buffer 3.

When the shot length calculated by the shot length calculating unit 2 is longer than a preset threshold A, an important shot determining unit 4 carries out a process of determining if the shot starting from the preceding cut point immediately preceding the cut point detected by the cut point detecting unit 1 is an important shot, determining if the next shot next to the shot starting from the immediately preceding cut point is an important shot, or determining if both the shot starting from the immediately preceding cut point and the next shot are important shots, and outputting the determination result. The important shot determining unit 4 constructs an important shot determining means.

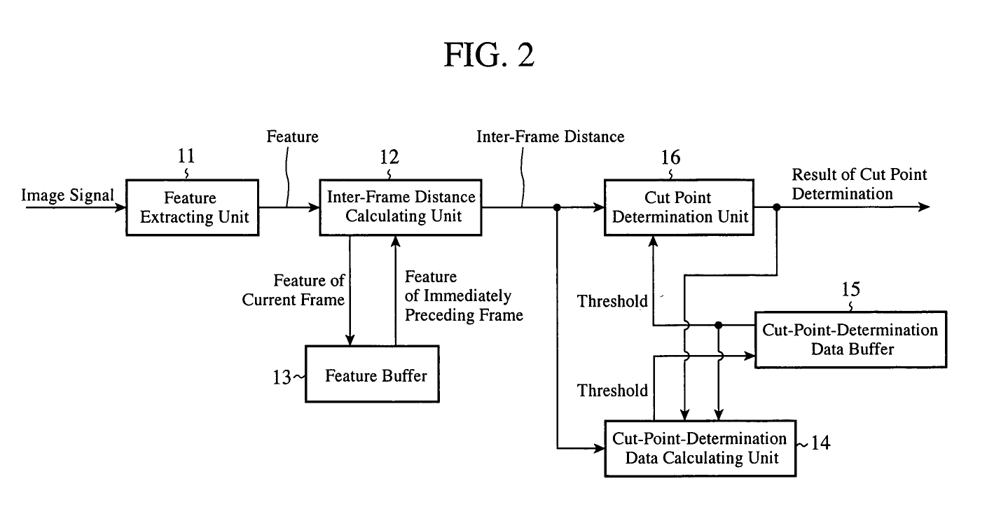

FIG. 2 is a block diagram showing the cut point detecting unit 1 of the image digesting apparatus in accordance with Embodiment 1 of the present invention. In the figure, a feature extracting part 11 carries out a process of, when receiving an image signal, extracting a feature indicating a feature of an image frame from the image signal. The feature extracting part 11 constructs a feature extracting means.

An inter-frame distance calculating part 12 carries out a process of comparing a feature of a current frame which is currently extracted by the feature extracting part 11 with a feature of an immediately preceding frame stored in a feature buffer 13 (i.e., a feature of a frame which was extracted the last time by the feature extracting part 11) using a predetermined evaluation function, and calculating the distance between those features (i.e., a degree of dissimilarity between them). Hereafter, the distance between the feature of the current frame and that of the immediately preceding frame is referred to as “the inter-frame distance.”

After the feature buffer 13 stores the feature of the immediately preceding frame and the inter-frame distance calculating part 12 then calculates the inter-frame distance, in order to prepare for calculation of the next inter-frame distance, the feature buffer 13 replaces the feature of the immediately preceding frame which it is storing currently with the feature of the current frame which has been extracted by the feature extracting part 11.

A distance calculating means is comprised of the inter-frame distance calculating part 12 and the feature buffer 13.

A cut-point-determination data calculating part 14 carries out a process of calculating statistics values of inter-frame distances which have been calculated by the inter-frame distance calculating part 12, calculating a threshold Th for determination of cut points from the statistics values, and outputting the threshold Th for determination of cut points to a cut-point-determination data buffer 15.

The cut-point-determination data buffer 15 is a memory for storing the threshold Th for determination of cut points which is calculated by the cut-point-determination data calculating part 14.

A threshold calculating means is comprised of the cut-point-determination data calculating part 14 and the cut-point-determination data buffer 15.

A cut point determination part 16 carries out a process of comparing the inter-frame distance calculated by the inter-frame distance calculating part 12 with the threshold Th for determination of cut points which is stored in the cut-point-determination data buffer 15 so as to determine a cut point from the comparison result. The cut point determination part 16 constructs a cut point determining means.

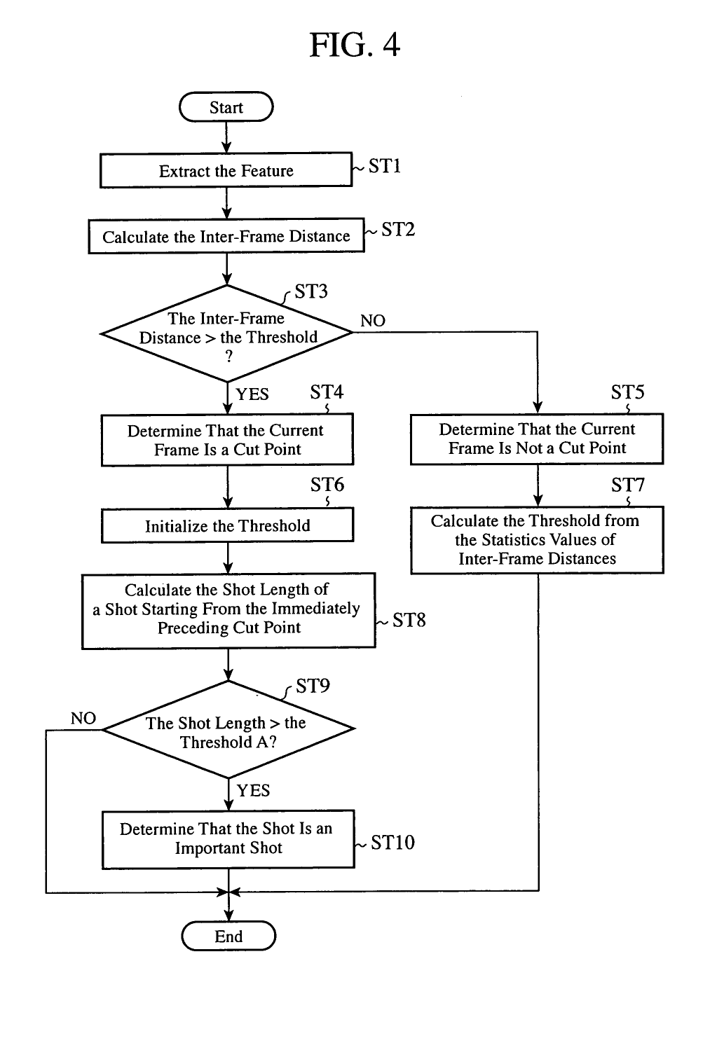

FIG. 4 is a flow chart showing a description of processing carried out by the image digesting apparatus in accordance with Embodiment 1 of the present invention.

Next, the operation of the image digesting apparatus will be explained.

When receiving an image signal, the cut point detecting unit 1 carries out a process of detecting cut points of the image.

Hereafter, a concrete description of the detection process of detecting cut points by the cut point detecting unit 1 will be explained. Because the cut point detecting unit 1 in accordance with this Embodiment 1 adopts a detection processing method different from a conventional detection processing method (e.g., a method of, when the difference in brightness between adjacent frames is larger than a fixed threshold, detecting, as a cut point, a change point of the frames: Nikkei electronics No. 892 2005.1.31, pp. 51), the cut point detecting unit 1 has a feature of being able to detect cut points correctly even when any type of image signal is inputted thereto.

However, the cut point detecting unit 1 has only to detect cut points of the image, and, in a case in which the accuracy of detection of cut points is not an issue, can use the conventional detection processing method so as to detect cut points of the image.

When receiving an image signal, the feature extracting part 11 of the cut point detecting unit 1 extracts a feature indicating a feature of a frame from the image signal (step ST1).

As the feature indicating the feature of a frame, for example, a histogram of colors, arrangement information about colors, texture information, motion information, or the like, other than the difference between the current frame and a preceding frame, can be provided. Either one of these features can be used, or a combination of two or more of the features can be used.

When the feature extracting part 11 extracts the feature of the current frame, the inter-frame distance calculating part 12 of the cut point detecting unit 1 reads out the feature of the immediately preceding frame (i.e., the feature of a frame which was extracted the last time by the feature extracting part 11) from the feature buffer 13.

The inter-frame distance calculating part 12 then compares the feature of the current frame with the feature of the immediately preceding frame using a predetermined evaluation function, and calculates the inter-frame distance which is the distance between those features (the degree of dissimilarity) (step ST2).

The inter-frame distance calculating part 12 replaces the memory content of the feature buffer 13 with the feature of the current frame after calculating the inter-frame distance.

After the inter-frame distance calculating part 12 calculates the inter-frame distance, the cut point determination part 16 of the cut point detecting unit 1 compares the inter-frame distance with the threshold Th for determination of cut points which is stored in the cut-point-determination data buffer 15 (step ST3).

When the inter-frame distance is larger than the threshold Th for determination of cut points, the cut point determination part 16 determines that the current frame is a cut point, and outputs the determination result showing that the current frame is a cut point (step ST4).

In contrast, when the inter-frame distance is not larger than the threshold Th for determination of cut points, the cut point determination part determines that the current frame is not a cut point, and outputs the determination result showing that the current frame is not a cut point (step ST5).

In this case, the cut point determination part 16 determines a cut point using the threshold Th for determination of cut points. As an alternative, the cut point determination part 16 can determine a cut point by using, for example, a shot time or the like.

The cut-point-determination data calculating part 14 of the cut point detecting unit 1 initializes the memory content of the cut-point-determination data buffer 15 to a predetermined value when the determination result of the cut point determination part 16 shows that the current frame is a cut point (step ST6).

In contrast, when the determination result of the cut point determination part 16 shows that the current frame is not a cut point, the cut-point-determination data calculating unit calculates the statistics values of inter-frame distances which have been calculated by the inter-frame distance calculating part 12, calculates the threshold Th for determination of cut points from the statistics values, and replaces the memory content of the cut-point-determination data buffer 15 with the threshold Th (step ST7).

Concretely, the cut-point-determination data calculating part calculates the threshold Th for determination of cut points as follows.

An actual image content consists of a plurality of shots, and it is hard to consider that a frame immediately after a cut which is a break between shots is a cut point and it can be considered that a shot includes a plurality of continuous frames.

Hereafter, for the sake of convenience in explanation, the distance between the (n−1)-th frame and the n-th frame of each shot is expressed as Distₙ.

It can be considered that the n-th frame of the i-th shot is actually the first frame of the (i+1)-th shot when this distance Distₙ is larger than a certain threshold. More specifically, it can be considered that the n-th frame of the i-th shot is a cut point. In this case, assume that the first frame of the i-th shot is the 0th frame. Furthermore, assume that the above-mentioned threshold is varied adaptively, and the threshold is expressed as Thᵢ_{_{—}}ₙ.

When calculating the threshold Thᵢ_{_{—}}ₙ, the cut-point-determination data calculating part 14 calculates the average avgᵢ(Distₙ) of the distances between frames in the i-th shot, and also calculates the variance varᵢ(Distₙ) of the distances between frames.

After calculating the average avgᵢ(Distₙ) of the distances and the variance varᵢ(Distₙ) of the distances, the cut-point-determination data calculating part 14 calculates the threshold Thᵢ_{_{—}}ₙ by substituting the average avgᵢ(Distₙ) of the distances and the variance varᵢ(Distₙ) of the distances into the following equation (1).

Thᵢ_{_{—}}ₙ=avgᵢ(Distₙ)+α·varᵢ(Distₙ) (1)

In the equation (1), α is a coefficient.

The average avgᵢ(Distₙ) and the variance varᵢ(Distₙ) are not the average and variance of the distances of all the frames in the i-th shot, but are the average and variance of the distances of the 1st to (n−1)-th frames in the i-th shot.

The reason why the 1st and subsequent frames are used for the calculation of the average and variance of the distances without using the 0th frame for the calculation of the average and variance of the distances is that the distance Dist₀ about the 0th frame shows the inter-frame distance between the 0th frame and the last frame of the immediately preceding shot.

Furthermore, the reason why up to the (n−1)-th frame is used for the calculation of the average and variance of the distances without using the n-th frame for calculation of the average and variance of the distances is that in the case of not using the n-th frame, the cut-point-determination data calculating part can determine promptly whether or not the inputted frame is a cut point.

The average avgᵢ(Distₙ) and the variance varᵢ(Distₙ) do not need to be accurate values, and certain approximate values can be used as them. The coefficient α can be varied according to the genre of the content, or the like.

As can be seen from the above description, even when there is a motion in a shot, the cut point detecting unit 1 can discriminate a cut point from a variation in the motion in the shot by analyzing the motion statistically, and can therefore set up the threshold Th for determination of cut points adaptively. As a result, as compared with a conventional case in which a fixed threshold is used, the image digesting apparatus can improve the accuracy of the detection of cut points. The reason is as follows.

In accordance with the conventional detection processing method, a change in the brightness value in a frame is used for detection of a cut point, and the threshold for detection of cut points is a fixed value.

In general, it is difficult to predict whether a shot will come after the current shot.

In a case in which similar shots continue, for example, in a case in which the image is created by changing cameras in the same studio, even a cut point may have a small change in the brightness value.

In contrast, in a case in which there is, for example, a flash or a person's large motion even in the same cut, a larger change (a large change in the brightness value) may appear between frames.

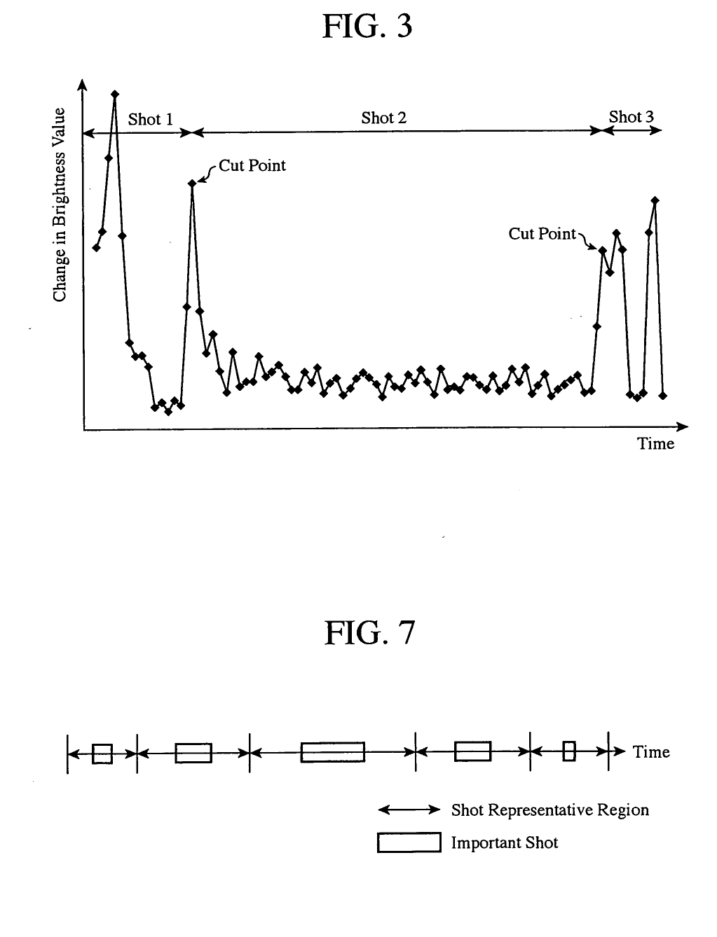

FIG. 3 is an explanatory drawing showing a change in the brightness value in such a case.

Therefore, in accordance with the conventional detection processing method, a setup of a large threshold causes an oversight of cut points having a small change, while a setup of a small threshold causes an erroneous detection of cut points in a shot having large variations.

In contrast with this, the cut point detecting unit 1 in accordance with this Embodiment 1 uses features instead of a simple difference in the brightness value to improve the general purpose characteristic of the apparatus. Furthermore, when a frame has a large distance which is an evaluation result of the evaluation function, it is determined that it is a cut point, and, by setting up the threshold adaptively, the threshold is made to become large automatically for a shot having large variations, whereas the threshold is made to become small automatically for a shot having small variations. Therefore, a large improvement in the accuracy of the detection of cut points and an improvement in the general purpose characteristic of the apparatus can be expected.

In this Embodiment 1, when extracting a feature, the feature can be extracted not from the image signal, but from coded data about an image compressed.

Furthermore, when calculating the inter-frame distance, the image discriminating apparatus does not necessarily calculate it from the features of two adjacent frames, but can calculate the inter-frame distance between the features of two frames spaced two or more frames, thereby speeding up the calculation processing.

When thus calculating the inter-frame distance between the features of two frames spaced two or more frames and then detecting cut points, the image discriminating apparatus can use frames using intra-frame coding in a coded image which is compressed with respect to time.

Furthermore, when calculating the average and variance of distances, the image discriminating apparatus can carry out a process of assigning a weight to a frame which is close to the current frame, and so on, to deal with a temporal change in variations in each shot.

When the determination result of the cut point determination part 16 in the cut point detecting unit 1 shows that the current frame is not a cut point, the shot length calculating unit 2 does not carry out any processing especially, whereas when the determination result of the cut point determination part 16 in the cut point detecting unit 1 shows that the current frame is a cut point, the shot length calculating unit calculates the shot length of a shot starting from a preceding cut point immediately preceding the cut point (step ST8).

More specifically, because the shot length calculating unit 2 can acquire the shot length of the shot from the difference between the start time of the i-th shot and the start time of the (i+1)-th shot, when the determination result of the cut point determination part 16 in the cut point detecting unit 1 shows that the current frame is a cut point, the shot length calculating unit calculates the time difference between the time of the current frame and that of the shot start point stored in the shot start point buffer 3, and outputs, as the shot length, the time difference to the important shot determining unit 4.

The shot length calculating unit 2 replaces the memory content of the shot start point buffer 3 with the time of the current frame after calculating the shot length.

After the shot length calculating unit 2 calculates the shot length, the important shot determining unit 4 compares the shot length with the preset threshold A (step ST9).

When the shot length is then longer than the preset threshold A, the important shot determining unit 4 determines that the shot starting from the preceding cut point immediately preceding the cut point detected by the cut point detecting unit 1 is an important shot, and outputs the determination result (step ST10).

In this case, the important shot determining unit 13 determines that the shot starting from the immediately preceding cut point is an important shot. As an alternative, the important shot determining unit can determine that the next shot next to the shot starting from the immediately preceding cut point is an important shot, or can determine that both the shot starting from the immediately preceding cut point and the next shot are important shots.

As can be seen from the above description, the image digesting apparatus in accordance with this embodiment 1 includes the shot length calculating unit 2 which, when the determination result of the cut point determination part 16 in the cut point detecting unit 1 shows that the current frame is a cut point, calculates the shot length of a shot starting from a preceding cut point immediately preceding the cut point, and is so constructed as to determine whether or not the shot starting from the immediately preceding cut point is an important shot by using, as a criterion of the determination, the shot length calculated by the shot length calculating unit 2. Therefore, the present embodiment offers an advantage of making it possible for the user to grasp an important shot easily without causing any increase in the calculation load by carrying out a very complicated process, such as a process based on one of a variety of image processing methods and sound processing methods.

This Embodiment 1 is based on the fact that in a case in which the image is a content principally consists of a conversation scene, the shot length of an important narration or a speech included in the conversation scene is long. Furthermore, in a case in which cut points are known, the image digesting apparatus is characterized in that its calculation load is dramatically small, and therefore the image digesting apparatus can carry out determination of an important shot even if it has a low calculation capability.

When determining cut points, the image digesting apparatus can speed up the processing using frames apart from each other instead of using adjacent frames. Also in this case, the start time of an important shot outputted deviates from the original start time of the important shot by a small time.

### Embodiment 2

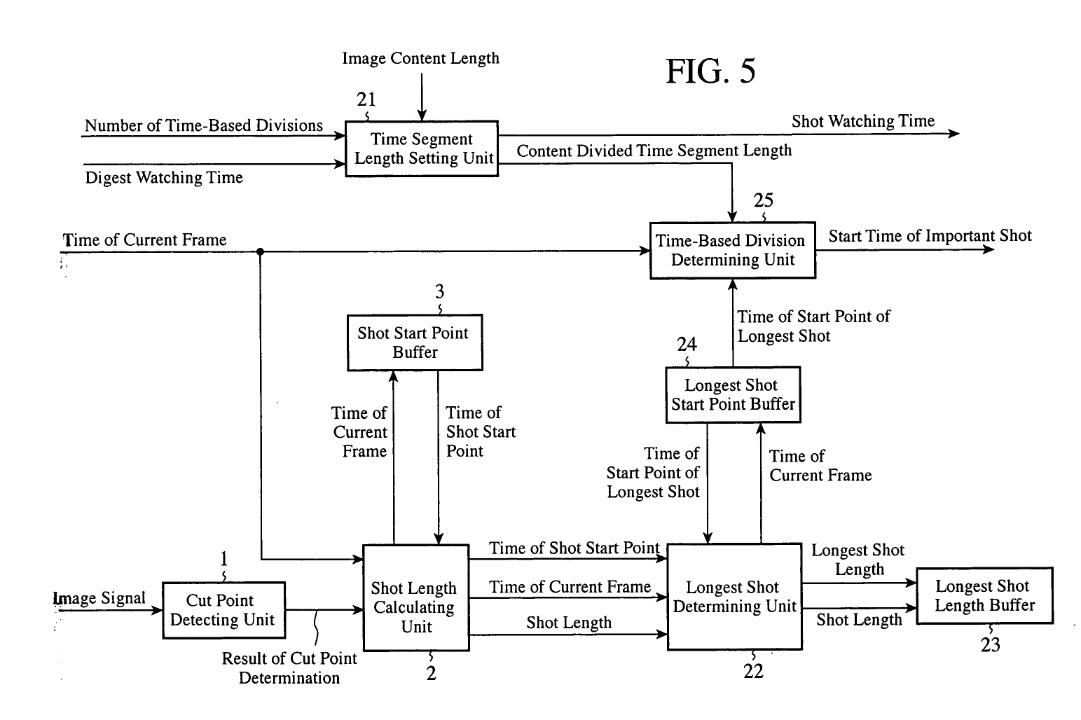

FIG. 5 is a block diagram showing an image digesting apparatus in accordance with Embodiment 2 of the present invention. In the figure, because the same reference numerals as those shown in FIG. 1 denote the same components or like components, the explanation of these components will be omitted hereafter.

A time segment length setting unit 21 carries out a process of setting both a content divided time segment length (a time segment length with which an image content is to be divided into time segments each having a time duration equal to the time segment length) and a shot watching time (a watching time per shot) from a digest watching time (a time during which a user desires to watch and listen to a digest), the number of time-based divisions of an image content, and an image content length, which have been set up by the user. The time segment length setting unit 21 constructs a time segment length setting means.

Every time when the shot length calculating unit 2 calculates a shot length, a longest shot determining unit 22 carries out a process of comparing shot lengths which have been calculated by the shot length calculating unit 2 with one another so as to determine a shot having the longest shot length.

A longest shot length buffer 23 is a memory for storing the shot length of the longest shot determined by the longest shot determining unit 22.

A longest shot start point buffer 24 is a memory for storing the time of the start point of the longest shot determined by the longest shot determining unit 22 (i.e., the time of a frame at the time when the longest shot is detected).

A time-based division determining unit 25 outputs the time of the start point of an important shot at a time defined by the content divided time segment length set up by the time segment length setting unit 21. More specifically, when the time of a current frame is an integral multiple of the content divided time segment length set up by the time segment length setting unit 21, the time-based division determining unit carries out a process of outputting the time of the start point of the longest shot stored in the longest shot start point buffer 24 as the start time of the important shot which is used for playback of a digest.

A longest shot detecting means is comprised of the longest shot determining unit 22, the longest shot length buffer 23, the longest shot start point buffer 24, and the time-based division determining unit 25.

Next, the operation of the image digesting apparatus will be explained.

When receiving a digest watching time T_{Dijest}, the number n of time-based divisions of an image content, and an image content length T_{content} which have been set up by a user, the time segment length setting unit 21 sets up the number Nₛₕₒₜ of important shots to be extracted, the content divided time segment length T_{segment}, and the shot watching time T_{Play} according to those pieces of input information.

Nₛₕₒₜ=n

T_{segment}=T_{content}/n

T_{play}=T_{Dijest}/n

In the case in which the time segment length setting unit sets up the parameters in this way, the user will watch and listen to only the T_{Play}-second head part of each of n shots.

For example, in a case in which the image content length T_{content} is 30 minutes (=1,800 seconds), the digest watching time T_{Dijest} is 5 minutes (=300 seconds), and the number n of time-based divisions of the image content is 10, the content divided time segment length T_{Segment} is set to 3 minutes (=180 seconds) and the shot watching time T_{Play} is set to 0.5 minutes (=30 seconds).

As an alternative, the time segment length setting unit 21 can input, instead of the numerical information, information expressed in words, and analyze the words so as to determine the digest watching time T_{Dijest}, the number n of time-based divisions of the image content, and the image content length T_{content}.

When receiving an image signal, the cut point detecting unit 1 carries out a process of detecting cut points of the image, like that of above-mentioned Embodiment 1.

When the cut point detecting unit 1 does not detect any cut point, the shot length calculating unit 2 does not carry out any processing especially, whereas when the cut point detecting unit 1 detects a cut point, the shot length calculating unit calculates the shot length of a shot starting from a preceding cut point immediately preceding the detected cut point, like that of above-mentioned Embodiment 1.

More specifically, when the cut point detecting unit 1 detects a cut point, the shot length calculating unit 2 calculates the time difference between the time of the current frame and that of the shot start point stored in the shot start point buffer 3 and outputs, as the shot length, the time difference to the longest shot determining unit 22.

The shot length calculating unit 2 replaces the memory content of the shot start point buffer 3 with the time of the current frame after calculating the shot length.

Every time when the shot length calculating unit 2 calculates a shot length, the longest shot determining unit 22 compares shot lengths which have been calculated by the shot length calculating unit 2 so as to determine a shot having the longest shot length.

More specifically, after the shot length calculating unit 2 calculates a shot length, the longest shot determining unit 22 compares the shot length calculated by the shot length calculating unit 2 with the shot length of the longest shot stored in the longest shot length buffer 23, and, when the shot length calculated by the shot length calculating unit 2 is longer than the shot length of the longest shot stored in the longest shot length buffer 23, determines that the shot whose shot length has been calculated by the shot length calculating unit 2 is the longest shot at present.

After determining the longest shot at present, the longest shot determining unit 22 replaces the memory content of the longest shot length buffer 23 with the shot length currently calculated by the shot length calculating unit 2.

The longest shot determining unit 22 replaces the memory content of the longest shot start point buffer 24 with the time of the start point of the longest shot (the time of the current frame).

The time-based division determining unit 25 outputs the time of the start point of an important shot at a time defined by the content divided time segment length T_{Segment} set up by the time segment length setting unit 21.

More specifically, in a case in which the time of the current frame is an integral multiple of the content divided time segment length T_{Segment} set up by the time segment length setting unit 21, the time-based division determining unit 25 outputs the time of the start point of the longest shot stored in the longest shot start point buffer 24 as the start time of the important shot which is used for playback of a digest.

In this embodiment, the time-based division determining unit 25 outputs the time of the start point of the longest shot, as mentioned above. As an alternative, the time-based division determining unit can output either the time of the start point of a next shot next to the longest shot, or the time of the start point of the longest shot and that of the next shot.

In this case, a buffer for storing the time of the start point of the next shot next to the longest shot needs to be disposed.

As can be seen from the above description, the image digesting apparatus in accordance with this embodiment 2 compares shot lengths which have been calculated by the shot length calculating unit 2 every time when shot length calculating unit 2 calculates a shot length, and detects a shot having the longest shot length, a next shot next to the longest shot, or the longest shot and the next shot at a time defined by a time segment length set up by the time segment length setting unit 21. Therefore, the present embodiment offers an advantage of making it possible for the user to grasp important shots easily without causing any increase in the calculation load by carrying out a very complicated process, such as a process based on one of a variety of image processing methods and sound processing methods.

In addition, because an application of this Embodiment 2 to a recording apparatus or playback equipment makes it possible to identify the start time of an important shot and the duration of playback of the important shot, automatic editing of the image can be implemented and simple watching and listening of playback of a digest of the image can be allowed.

The image digesting apparatus can speed up the processing of determining cut points by using frames apart from each other, instead of using adjacent frames. Also in this case, the start time of an important shot outputted deviates from the original start time of the important shot by a small time.

### Embodiment 3

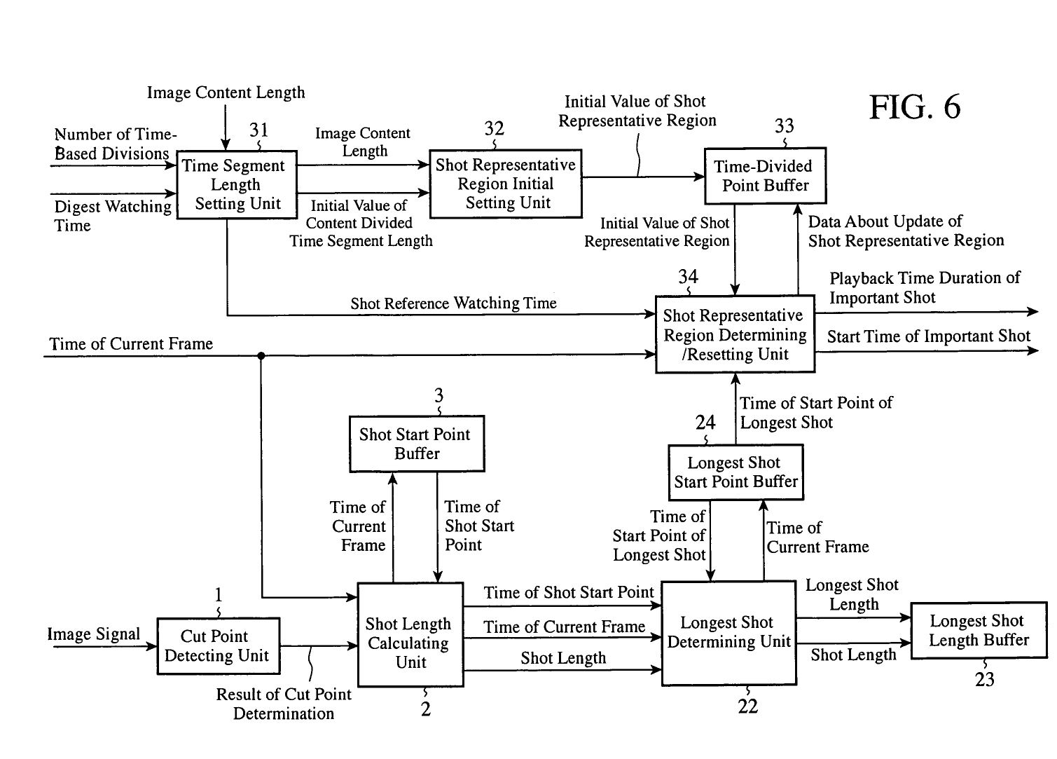

FIG. 6 is a block diagram showing an image digesting apparatus in accordance with Embodiment 3 of the present invention. In the figure, because the same reference numerals as those shown in FIG. 5 denote the same components or like components, the explanation of these components will be omitted hereafter.

A time segment length setting unit 31 carries out a process of setting both an initial value of a content divided time segment length and a shot reference watching time (a watching time per shot) from a digest watching time, the number of time-based divisions of an image content, and an image content length, which have been set up by a user.

A shot representative region initial setting unit 32 carries out a process of setting up an initial value of a shot representative region (the shot representative region consists of a shot representative region start point and a temporary shot representative region end point) from the initial value of the content divided time segment length set up by the time segment length setting unit 31 and the image content length.

A time-divided point buffer 33 is a memory for storing the initial value of the shot representative region which is set up by the shot representative region initial setting unit 32.

When the time of a current frame exceeds an end point of the shot representative region, a shot representative region determining/resetting unit 34 calculates and outputs an important shot playback time duration, and also outputs the time of the start point of the longest shot stored in the longest shot start point buffer 24 as the start time of the important shot which is used for playback of the digest. The shot representative region determining/resetting unit 34 also generates update information about update of the shot representative region and updates the memory content of the time-divided point buffer 33.

A time segment length setting means is comprised of the time segment length setting unit 31, the shot representative region initial setting unit 32, the time-divided point buffer 33, and the shot representative region determining/resetting unit 34.

Next, the operation of the image digesting apparatus will be explained.

When receiving a digest watching time T_{Dijest}, the number n of time-based divisions of an image content, and an image content length T_{content}, which have been set up by a user, the time segment length setting unit 31 sets up the number Nₛₕₒₜ of important shots to be extracted, the initial value T_{segment0} of the content divided time segment length, and the shot reference watching time T_{play0} according to those pieces of input information.

Nₛₕₒₜ=n

T_{Segment0}=T_{content}/n

T_{Play0}=T_{Dijest}/n

For example, in a case in which the image content length T_{Content} is 30 minutes (=1,800 seconds), the digest watching time T_{Dijest} is 5 minutes (=300 seconds), and the number n of time-based divisions of the image content is 10, the initial value T_{Segment0} of the content divided time segment length is set to 3 minutes (=180 seconds) and the shot reference watching time T_{play0} is set to 0.5 minutes (=30 seconds).

As an alternative, the time segment length setting unit 31 can input, instead of the numerical information, information expressed in words, and analyze the words so as to determine the digest watching time T_{Dijest}, the number n of time-based divisions of the image content, and the image content length T_{Content}.

After the time segment length setting unit 31 sets up the initial value T_{segment0} of the content divided time segment length, the shot representative region initial setting unit 32 sets up the initial value of the shot representative region (the start point P_{Start} of the shot representative region and the end point P_{End}_{_{—}}ₜₑₘₚ of a temporary shot representative region) from the initial value T_{Segment0} of the content divided time segment length and the image content length T_{Content}.

P_{Start}=0

P_{End}_{_{—}}ₜₑₘₚ=T_{Content}/Nₛₕₒₜ=T_{Segment0}

FIG. 7 is an explanatory drawing showing, in a case in which an important shot exists for each of divided regions into which the image content is divided, a region represented by the shot.

The shot representative region initial setting unit 32 stores the initial value of the shot representative region in the time-divided point buffer 33 after setting up the initial value of the shot representative region.

When receiving an image signal, the cut point detecting unit 1 carries out a process of detecting cut points of the image, like that of above-mentioned Embodiment 1.

When the cut point detecting unit 1 does not detect any cut point, the shot length calculating unit 2 does not carry out any processing especially, whereas when the cut point detecting unit 1 detects a cut point, the shot length calculating unit calculates the shot length of a shot starting from a preceding cut point immediately preceding the detected cut point, like that of above-mentioned Embodiment 1.

More specifically, when the cut point detecting unit 1 detects a cut point, the shot length calculating unit 2 calculates the time difference between the time of the current frame and that of the shot start point stored in the shot start point buffer 3 and outputs, as the shot length, the time difference to the longest shot determining unit 22.

The shot length calculating unit 2 replaces the memory content of the shot start point buffer 3 with the time of the current frame after calculating the shot length.

Every time when the shot length calculating unit 2 calculates a shot length, the longest shot determining unit 22 compares shot lengths which have been calculated by the shot length calculating unit 2 with one another so as to determine a shot having the longest shot length, like that of above-mentioned Embodiment 2.

More specifically, after the shot length calculating unit 2 calculates a shot length, the longest shot determining unit 22 compares the shot length currently calculated by the shot length calculating unit 2 with the shot length of the longest shot stored in the longest shot length buffer 23, and, when the shot length currently calculated by the shot length calculating unit 2 is longer than the shot length of the longest shot stored in the longest shot length buffer 23, determines that the shot whose shot length is currently calculated by the shot length calculating unit 2 is the longest shot at present.

After determining the longest shot at present, the longest shot determining unit 22 replaces the memory content of the longest shot length buffer 23 with the shot length currently calculated by the shot length calculating unit 2.

The longest shot determining unit 22 also replaces the memory content of the longest shot start point buffer 24 with the time of the start point of the longest shot (the time of the current frame).

When the time P_{Now} of the current frame exceeds the end point P_{End}_{_{—}}ₜₑₘₚ of the temporary shot representative region stored in the time-divided point buffer 33, the shot representative region determining/resetting unit 34 operates in a way as will be mentioned below so as to calculate the end point P_{End} of the shot representative region and the important shot playback time duration T_{Play}, and outputs the important shot playback time duration T_{Play}.

P_{End}=P_{Now}+P_{Shot}_{_{—}}_{Start}−P_{Start}

T_{Play}=(P_{End}−P_{Start})*T_{Play0}/T_{Segment0}

where P_{Shot}_{_{—}}_{Start} shows the time of the start point of the longest shot stored in the longest shot start point buffer 24.

When the time P_{Now} of the current frame exceeds the end point P_{End}_{_{—}}ₜₑₘₚ of the temporary shot representative region stored in the time-divided point buffer 33, the shot representative region determining/resetting unit 34 outputs the time P_{Shot}_{_{—}}_{Start} of the start point of the longest shot stored in the longest shot start point buffer 24 as the start time of an important shot which is used for playback of a digest, and updates the start point P_{Start} of the shot representative region and the end point P_{End}_{_{—}}ₜₑₘₚ of the temporary shot representative region which are stored in the time-divided point buffer 33.

The updated shot representative region is given as follows.

P_{Start}=P_{End}

P_{End}_{_{—}}ₜₑₘₚ=P_{End}+T_{Content}/Nₛₕₒₜ=P_{End}+T_{Segment0}

As can be seen from the above description, because the image digesting apparatus in accordance with this embodiment 3 is so constructed as to update the shot representative region according to both the start time of the longest shot determined by the longest shot determining unit 22, and the shot length, there is provided an advantage of making it possible to change breakpoints of the content and the playback time duration of an important shot in a divided segment of the content adaptively.

Above-mentioned Embodiment 2 is effective for a case in which the content is divided into segments which are equal with respect to time, and it is preferable to use either above-mentioned Embodiment 2 or Embodiment 3 properly according to the genre of the content.

### Embodiment 4

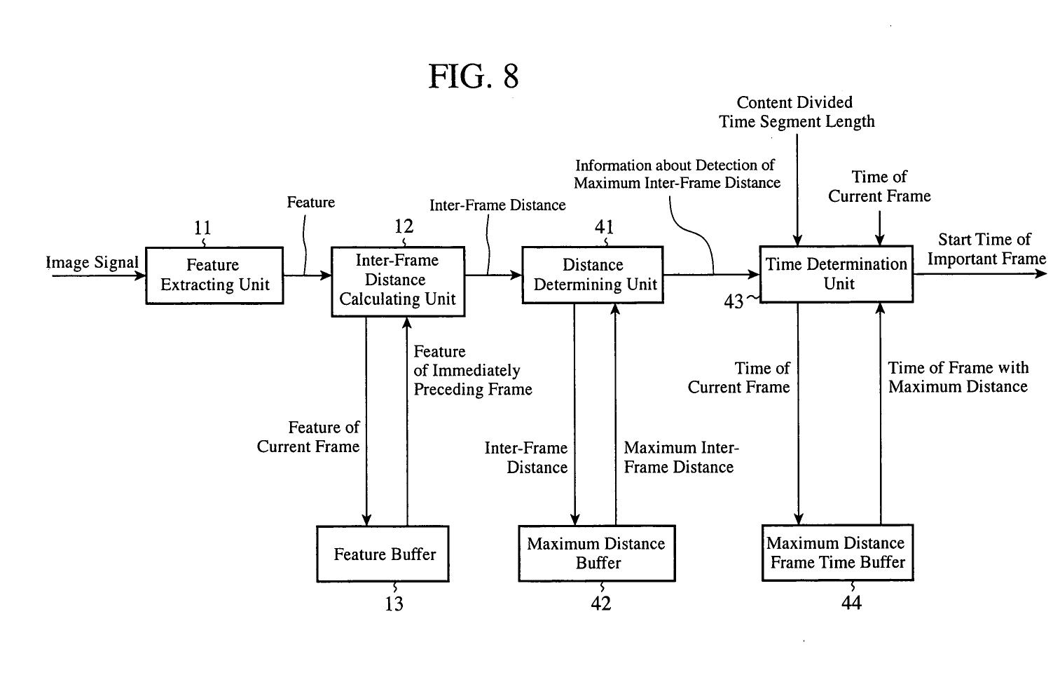

FIG. 8 is a block diagram showing an image digesting apparatus in accordance with Embodiment 4 of the present invention. In the figure, because the same reference numerals as those shown in FIG. 2 denote the same components or like components, the explanation of these components will be omitted hereafter.

Every time when an inter-frame distance calculating unit 12 calculates an inter-frame distance, a distance determining unit 41 carries out a process of comparing inter-frame distances which have been calculated by the inter-frame distance calculating unit 12 with one another so as to determine a maximum inter-frame distance. More specifically, the distance determining unit compares the inter-frame distance currently calculated by the inter-frame distance calculating unit 12 with the maximum inter-frame distance stored in a maximum distance buffer 42, and, when the inter-frame distance calculated by the inter-frame distance calculating unit 12 is larger than the maximum inter-frame distance, outputs detection information showing that it has detected the new maximum inter-frame distance to a time determination unit 43, and also replaces the memory content of the maximum distance buffer 42 with the inter-frame distance currently calculated by the inter-frame distance calculating unit 12.

The maximum distance buffer 42 is a memory for storing the maximum inter-frame distance determined by the distance determining unit 41.

A maximum distance detecting means is comprised of the distance determining unit 41 and the maximum distance buffer 42.

When receiving the detection information on the maximum inter-frame distance from the distance determining unit 41, the time determination unit 43 calculates the time difference between the time of a frame stored in a maximum distance frame time buffer 44 (i.e., the time of a frame at the time when detection information was received the last time from the distance determining unit 41) and the time of the current frame. When the time difference is larger than a preset content divided time segment length (a time segment length with which the image content is divided into parts each having a time duration equal to the time segment length), the time determination unit carries out a process of outputting the time of the current frame as the start time of an important frame, and replacing the memory content of the maximum distance frame time buffer 44 with the time of the current frame.

The maximum distance frame time buffer 44 is a memory for storing the time of a frame at the time when the maximum distance is determined.

An important frame detection means is comprised of the time determination unit 43 and the maximum distance frame time buffer 44.

Next, the operation of the image digesting apparatus will be explained.

When receiving an image signal, a feature extracting unit 11 extracts a feature indicating a feature of a frame from the image signal, like that of above-mentioned Embodiment 1.

As the feature indicating the feature of a frame, for example, a histogram of colors, arrangement information about colors, texture information, motion information, or the like, other than the difference between the current frame and a preceding frame, can be provided. Either one of these features can be used, or a combination of two or more of the features can be used.

When the feature extracting unit 11 extracts the feature of the current frame, the inter-frame distance calculating unit 12 reads out the feature of the immediately preceding frame (i.e., the feature of the frame which was extracted the last time by the feature extracting unit 11) from the feature buffer 13, like that of above-mentioned Embodiment 1.

The inter-frame distance calculating unit 12 then compares the feature of the current frame with the feature of the immediately preceding frame using a predetermined evaluation function, and calculates the inter-frame distance which is the distance between those features (a degree of dissimilarity).

The inter-frame distance calculating unit 12 replaces the memory content of the feature buffer 13 with the feature of the current frame after calculating the inter-frame distance.

Every time when the inter-frame distance calculating unit 12 calculates an inter-frame distance, the distance determining unit 41 compares inter-frame distances which have been calculated by the inter-frame distance calculating unit 12 with one another so as to determine a maximum inter-frame distance.

More specifically, when the inter-frame distance calculating unit 12 calculates an inter-frame distance, the distance determining unit 41 compares the inter-frame distance with the maximum inter-frame distance stored in the maximum distance buffer 42, and, when the inter-frame distance currently calculated by the inter-frame distance calculating unit 12 is larger than the maximum inter-frame distance, outputs detection information showing that it has detected the new maximum inter-frame distance to the time determination unit 43.

At that time, the distance determining unit 41 replaces the memory content of the maximum distance buffer 42 with the inter-frame distance currently calculated by the inter-frame distance calculating unit 12.

When receiving the detection information on the maximum inter-frame distance from the distance determining unit 41, the time determination unit 43 calculates the time difference between the time of a frame stored in the maximum distance frame time buffer 44 (the time of a frame at the time when detection information was received the last time from the distance determining unit 41) and the time of the current frame.

When the time difference is larger than a preset content divided time segment length, the time determination unit 43 then outputs the time of the current frame as the start time of an important frame, and replaces the memory content of the maximum distance frame time buffer 44 with the time of the current frame.

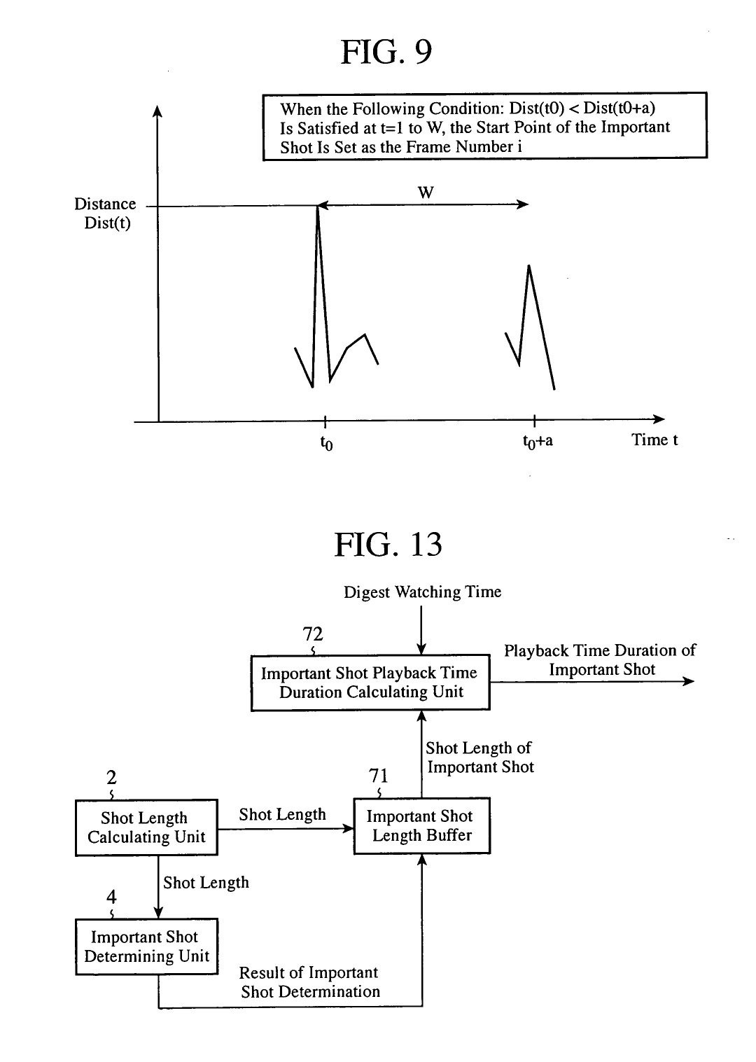

As can be seen from the above description, the image digesting apparatus in accordance with this embodiment 4 is so constructed as to, when receiving detection information on the maximum inter-frame distance from the distance determining unit 41, calculate the time difference between the time of a frame stored in the maximum distance frame time buffer 44 and the time of the current frame, and, when the time difference is larger than a preset content divided time segment length, output the time of the current frame as the start time of an important frame. Therefore, the image digesting apparatus makes it possible to find out a point having a large change in the content only with the inter-frame distance and the time segment length while maintaining the time segment length (see FIG. 9). As a result, automatic editing of the image can be implemented and simple watching and listening of playback of a digest of the image can be allowed with a very small calculation load.

The image digesting apparatus can speed up the processing by using frames apart from each other, instead of using adjacent frames, when calculating the inter-frame distance.

### Embodiment 5

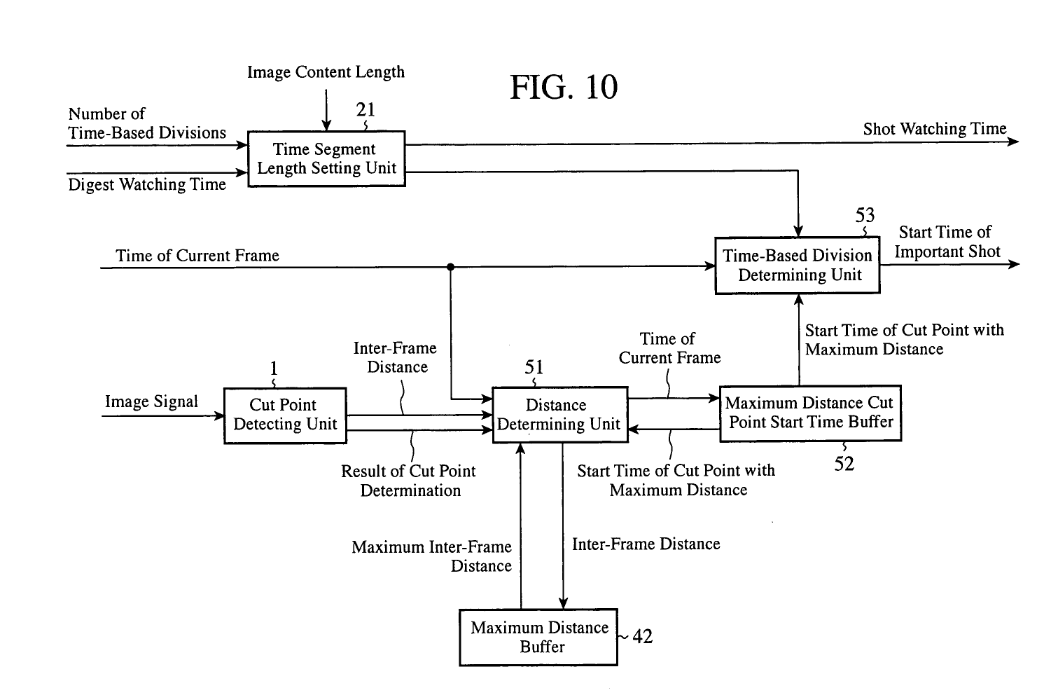

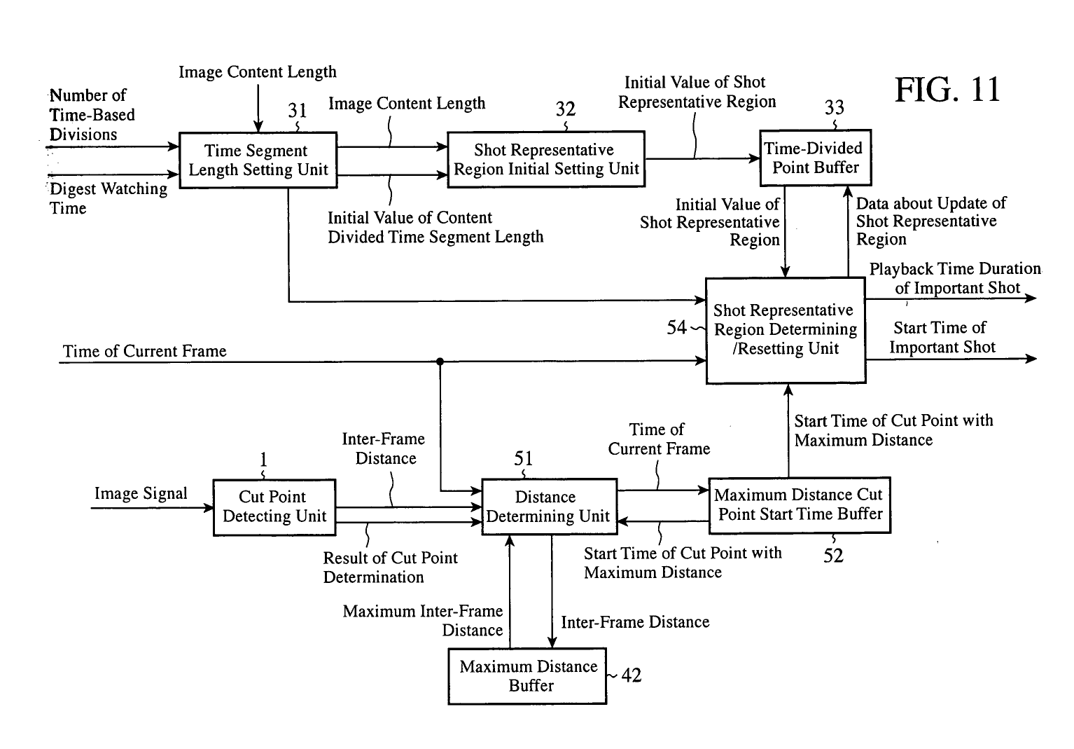

FIG. 10 is a block diagram showing an image digesting apparatus in accordance with Embodiment 5 of the present invention. In the figure, because the same reference numerals as those shown in FIG. 5 denote the same components or like components, the explanation of these components will be omitted hereafter.

In a case in which a cut point is detected by the cut point detecting unit 1, a distance determining unit 51 carries out a process of comparing inter-frame distances which have been calculated by the inter-frame distance calculating unit 12 with one another so as to determine a maximum inter-frame distance every time when the inter-frame distance calculating unit 12 calculates an inter-frame distance. More specifically, the distance determining unit compares the inter-frame distance currently calculated by the inter-frame distance calculating unit 12 with the maximum inter-frame distance stored in the maximum distance buffer 42, and, when the inter-frame distance currently calculated by the inter-frame distance calculating unit 12 is larger than the maximum inter-frame distance, replaces the memory content of a maximum distance cut point start time buffer 52 with the time of the current frame, and also replaces the memory content of the maximum distance buffer 42 with the inter-frame distance currently calculated by the inter-frame distance calculating unit 12.

The maximum distance cut point start time buffer 52 is a memory for storing the start time of a cut point having the maximum inter-frame distance.

A maximum distance detecting means is comprised of the distance determining unit 51, the maximum distance buffer 42, and the maximum distance cut point start time buffer 52.

A time-based division determining unit 53 outputs the time of the start point of an important shot at a time defined by the content divided time segment length set up by the time segment length setting unit 21. More specifically, when the time of the current frame is an integral multiple of the content divided time segment length set up by the time segment length setting unit 21, the time-based division determining unit carries out a process of outputting the start time of a cut point having the maximum inter-frame distance stored in the maximum distance cut point start time buffer 52 as the start time of an important shot which is used for playback of a digest.

The time-based division determining unit 53 constructs an important shot detecting means.

Next, the operation of the image digesting apparatus will be explained.

When receiving a digest watching time T_{Dijest}, the number n of time-based divisions of an image content, and an image content length T_{content}, which have been set up by a user, the time segment length setting unit 21 sets up the number Nₛₕₒₜ of important shots to be extracted, a content divided time segment length T_{segment}, and a shot watching time T_{Play} according to those pieces of input information, like that of above-mentioned Embodiment 2.

Nₛₕₒₜ=n

T_{Segment}=T_{Content}/n

T_{Play}=T_{Dijest}/n

When receiving an image signal, the cut point detecting unit 1 carries out a process of detecting cut points of the image, like that of above-mentioned Embodiment 1.

When the feature extracting unit 11 extracts a feature of a current frame, the inter-frame distance calculating part 12 of the cut point detecting unit 1 calculates an inter-frame distance, like that of above-mentioned Embodiment 1 (see FIG. 2).

After the cut point detecting unit 1 detects a cut point, the distance determining unit 51 compares inter-frame distances which have been calculated by the inter-frame distance calculating unit 12 with one another so as to determine a maximum inter-frame distance every time when the inter-frame distance calculating unit 12 calculates an inter-frame distance.

More specifically, the distance determining unit 51 compares the inter-frame distance currently calculated by the inter-frame distance calculating unit 12 with the maximum inter-frame distance stored in the maximum distance buffer 42, and, when the inter-frame distance currently calculated by the inter-frame distance calculating unit 12 is larger than the maximum inter-frame distance, replaces the memory content of the maximum distance cut point start time buffer 52 with the time of the current frame, and also replaces the memory content of the maximum distance buffer 42 with the inter-frame distance currently calculated by the inter-frame distance calculating unit 12.

The time-based division determining unit 53 outputs the time of the start point of an important shot at a time defined by the content divided time segment length T_{Segment} set up by the time segment length setting unit 21.

More specifically, when the time of the current frame is an integral multiple of the content divided time segment length T_{Segment} set up by the time segment length setting unit 21, the time-based division determining unit 53 carries out a process of outputting the start time of a cut point having the maximum inter-frame distance stored in the maximum distance cut point start time buffer 52 as the start time of an important shot which is used for playback of a digest.

As can be seen from the above description, the image digesting apparatus in accordance with this embodiment 5 includes the distance determining unit 51 for, in a case in which a cut point is detected by the cut point detecting unit 1, comparing inter-frame distances which have been calculated by the inter-frame distance calculating unit 12 every time when the inter-frame distance calculating unit 12 calculates an inter-frame distance, and is so constructed as to output, as the start time of an important shot, the time of a frame which has been detected to have the maximum inter-frame distance by the distance determining unit 51 at a time defined by a time segment length set up by the time segment length setting unit. Therefore, the image digesting apparatus makes it possible to divide the image content into parts which are equal with respect to time and to detect a cut point having a large change in each divided time segment as a representative scene in each time segment. As a result, automatic editing of the image can be implemented and simple watching and listening of playback of a digest of the image can be allowed with a very small calculation load.

The image digesting apparatus can speed up the processing using frames apart from each other, instead of using adjacent frames, when calculating the inter-frame distance.

### Embodiment 6

FIG. 11 is a block diagram showing an image digesting apparatus in accordance with Embodiment 6 of the present invention. In the figure, because the same reference numerals as those shown in FIGS. 6 and 10 denote the same components or like components, the explanation of these components will be omitted hereafter.

When the time of a current frame exceeds the end point of a shot representative region, a shot representative region determining/resetting unit 54 calculates and outputs an important shot playback time duration, and also outputs the time of the start point of a cut point having a maximum inter-frame distance stored in the maximum distance cut point start time buffer 52 as the start time of an important shot which is used for playback of a digest. The shot representative region determining/resetting unit 54 also generates update information about update of the shot representative region and updates the memory content of the time-divided point buffer 33.

A time segment length setting means is comprised of the time segment length setting unit 31, the shot representative region initial setting unit 32, the time-divided point buffer 33, and the shot representative region determining/resetting unit 54.

Next, the operation of the image digesting apparatus will be explained.

When receiving a digest watching time T_{Dijest}, the number n of time-based divisions of an image content, and an image content length T_{Content} which have been set up by a user, the time segment length setting unit 31 sets up the number Nₛₕₒₜ of important shots to be extracted, the initial value T_{Segment0} of the content divided time segment length, and the shot reference watching time T_{play0} according to those pieces of input information.

Nₛₕₒₜ=n

T_{Segment0}=T_{Content}/n

T_{Play0}=T_{Dijest}/n

After the time segment length setting unit 31 sets up the initial value T_{Segment0} of the content divided time segment length, the shot representative region initial setting unit 32 sets up the initial value of the shot representative region (the start point P_{Start} of the shot representative region and the end point P_{End}_{_{—}}ₜₑₘₚ of a temporary shot representative region) from the initial value T_{Segment0} of the content divided time segment length and the image content length T_{content}, like that of above-mentioned Embodiment 3.

P_{Start}=0

P_{End}_{_{—}}ₜₑₘₚ=T_{Content}/Nₛₕₒₜ=T_{Segment0}

After setting up the initial value of the shot representative region, the shot representative region initial setting unit 32 stores the initial value of the shot representative region in the time-divided point buffer 33.

When receiving an image signal, the cut point detecting unit 1 carries out a process of detecting cut points of the image, like that of above-mentioned Embodiment 1.

When the feature extracting unit 11 extracts a feature of a current frame, the inter-frame distance calculating part 12 of the cut point detecting unit 1 calculates an inter-frame distance, like that of above-mentioned Embodiment 1 (see FIG. 2).

In a case in which a cut point is detected by the cut point detecting unit 1, when the inter-frame distance calculating unit 12 calculates an inter-frame distance, the distance determining unit 51 compares the inter-frame distance currently with the maximum inter-frame distance stored in the maximum distance buffer 42, and, when the inter-frame distance currently calculated by the inter-frame distance calculating unit 12 is larger than the maximum inter-frame distance, replaces the memory content of the maximum distance cut point start time buffer 52 with the time of the current frame, and also replaces the memory content of the maximum distance buffer 42 with the inter-frame distance currently calculated by the inter-frame distance calculating unit 12, like that of above-mentioned Embodiment 5.

When the time P_{Now} of the current frame exceeds the end point P_{End}_{_{—}}ₜₑₘₚ of the temporary shot representative region stored in the time-divided point buffer 33, the shot representative region determining/resetting unit 54 calculates the end point P_{End} of the shot representative region and the important shot playback time duration T_{Play} as follows, and outputs the important shot playback time duration T_{Play}.

P_{End}=P_{Now}+P_{Shot}_{_{—}}_{Start}−P_{Start}

T_{Play}=(P_{End}−P_{Start})*T_{Play0}/T_{Segment0}

where P_{Shot}_{_{—}}_{Start} is the start time of the cut point having the maximum inter-frame distance which is stored in the maximum distance cut point start time buffer 52.

Furthermore, when the time P_{Now} of the current frame exceeds the end point P_{End}_{_{—}}ₜₑₘₚ of the temporary shot representative region stored in the time-divided point buffer 33, the shot representative region determining/resetting unit 54 outputs the start time P_{Shot}_{_{—}}ₛₜₐᵣₜ of the cut point having the maximum inter-frame distance stored in the maximum distance cut point start time buffer 52 as the start time of an important shot which is used for playback of a digest, and updates both the start point P_{Start} of the shot representative region and the end point P_{End}_{_{—}}ₜₑₘₚ of the temporary shot representative region which are stored in the time-divided point buffer 33.

The updated shot representative region is given as follows.

P_{Start}=P_{End}

P_{End}_{_{—}}ₜₑₘₚ=P_{End}+T_{Content}/Nₛₕₒₜ=P_{End}+T_{Segment0}

As can be seen from the above description, because the image digesting apparatus in accordance with this embodiment 6 is so constructed as to update the shot representative region according to the time of a frame when has been detected to have a maximum inter-frame distance by the distance determining unit 51, there is provided an advantage of making it possible to change breakpoints of the content and the playback time duration of an important shot in a divided part of the content adaptively.

Above-mentioned Embodiment 5 is effective for a case in which the content is divided into parts which are equal with respect to time, and it is preferable to use either above-mentioned Embodiment 5 or Embodiment 6 properly according to the genre of the content.

### Embodiment 7

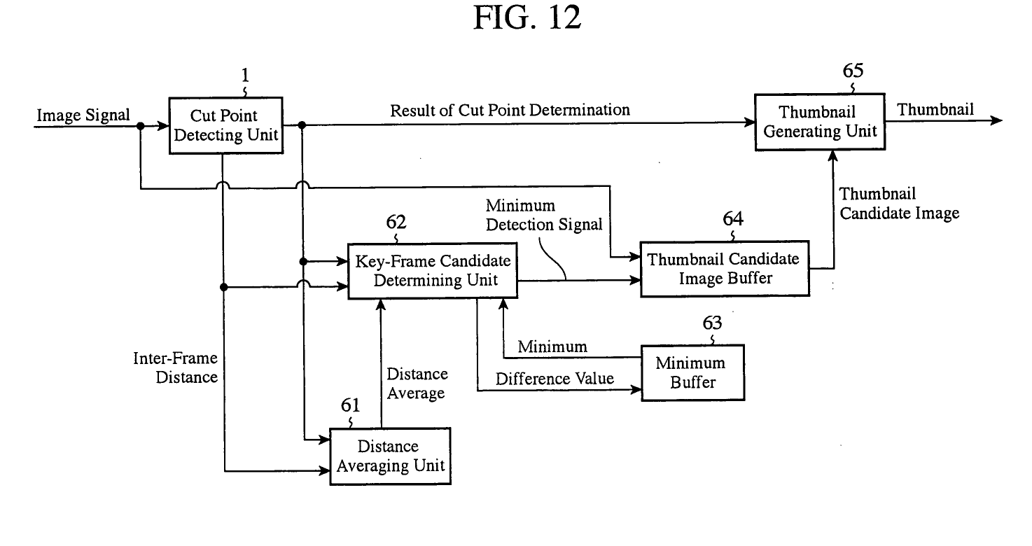

FIG. 12 is a block diagram showing an image digesting apparatus in accordance with Embodiment 7 of the present invention. In the figure, because the same reference numerals as those shown in FIG. 1 denote the same components or like components, the explanation of these components will be omitted hereafter.

Every time when the inter-frame distance calculating part 12 of the cut point detecting unit 1 calculates an inter-frame distance, a distance averaging unit 61 carries out a process of calculating the average of inter-frame distances which have been calculated by the inter-frame distance calculating unit 12. The distance averaging unit 61 constructs an average value calculation means.

When the difference value between the inter-frame distance currently calculated by the inter-frame distance calculating unit 12 and the average calculated by the averaging unit 61 is smaller than a minimum stored in a minimum buffer 63, a key-frame candidate determining unit 62 outputs a minimum detection signal showing that the difference value is smaller than the minimum to a thumbnail candidate image buffer 64, and also replaces the memory content of the minimum buffer 63 with the difference value.

The minimum buffer 63 is a memory for storing the minimum, and the thumbnail candidate image buffer 64 is a memory for storing images of an image signal as thumbnail candidate images when receiving the minimum detection signal from the key-frame candidate determining unit 62.

A thumbnail candidate image storage means is comprised of the key-frame candidate determining unit 62, the minimum buffer 63, and the thumbnail candidate image buffer 64.

A thumbnail generating unit 65 carries out a process of generating a thumbnail from the thumbnail candidate images stored in the thumbnail candidate image buffer 64 when the cut point detecting unit 1 detects a cut point. The thumbnail generating unit 65 constructs a thumbnail creating means.

Next, the operation of the image digesting apparatus will be explained.

When receiving an image signal, the cut point detecting unit 1 carries out a process of detecting cut points of the image, like that of above-mentioned Embodiment 1.

When the feature extracting unit 11 extracts a feature of a current frame, the inter-frame distance calculating part 12 of the cut point detecting unit 1 calculates an inter-frame distance, like that of above-mentioned Embodiment 1 (see FIG. 2).

In a case in which the cut point detecting unit 1 has determined that the current frame is not a cut point, the distance averaging unit 61 calculates the average of inter-frame distances which have been calculated by the inter-frame distance calculating unit 12 every time when the inter-frame distance calculating unit 12 calculates an inter-frame distance.

When the distance averaging unit 61 calculates the average of inter-frame distances in the case in which the cut point detecting unit 1 has determined that the current frame is not a cut point, the key-frame candidate determining unit 62 calculates the difference value between the inter-frame distance currently calculated by the inter-frame distance calculating unit 12 and the average calculated by the averaging unit 61, and compares the difference value with the minimum stored in the minimum buffer 63.

When the difference value is smaller than the minimum stored in the minimum buffer 63, the key-frame candidate judgment unit 62 outputs a minimum detection signal showing that the difference value is smaller than the minimum to the thumbnail candidate image buffer 64, and also replaces the memory content of the minimum buffer 63 with the difference value.

The thumbnail candidate image buffer 64 stores images of the image signal as thumbnail candidate images when receiving the minimum detection signal from the key-frame candidate determining unit 62.

When the cut point detecting unit 1 detects a cut point, the thumbnail generating unit 65 reads the thumbnail candidate images stored in the thumbnail candidate image buffer 64, and generates a thumbnail from the thumbnail candidate images and outputs the thumbnail.

The image digesting apparatus can speed up the processing using frames apart from each other, instead of using adjacent frames, when calculating the inter-frame distance.

Generally, even in the same shot of an image content, a difference may appear in images of the shot due to panning, tilting, or zooming of the camera and a person's motion.

Furthermore, in many cases, an image which was captured by panning, tilting, or zooming the camera, or an image in which any person's motion has become calm is an important image in the shot.

At this time, the inter-frame distance Distₙ becomes small, and when this state continues for a long time, the average avgᵢ(Distₙ) of inter-frame distances becomes small.

In this Embodiment 7, the n-th image whose |Distₙ−avgᵢ(Distₙ)| is minimized is defined as the representative image of the i-th shot.

As a result, an image representing each shot can be detected effectively, and the user can play back a scene which he or she desires to watch and listen to selectively from the image content more easily.

### Embodiment 8

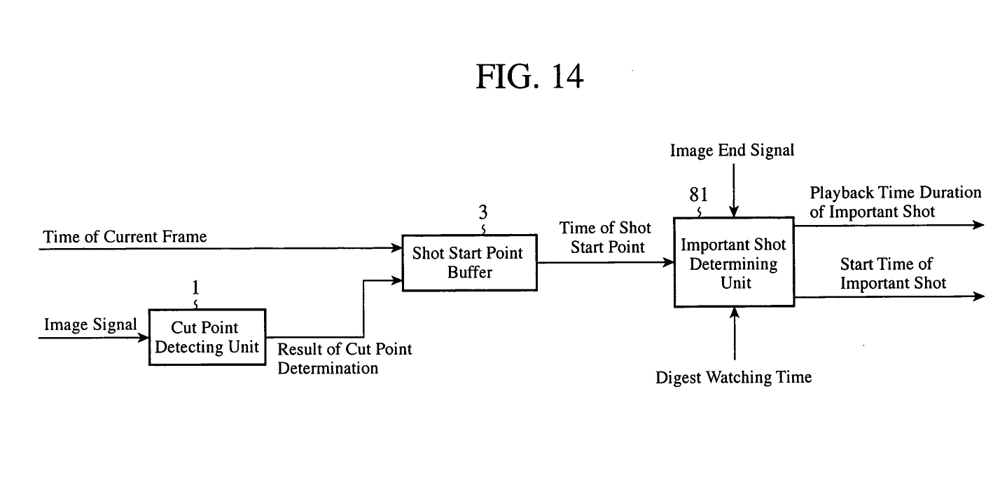

FIG. 13 is a block diagram showing an image digesting apparatus in accordance with Embodiment 8 of the present invention. In the figure, because the same reference numerals as those shown in FIG. 1 denote the same components or like components, the explanation of these components will be omitted hereafter.

An important shot length buffer 71 is a memory for, when the important shot discrimination unit 4 detects an important shot, storing the shot length of the important shot calculated by the shot length calculating unit 2. The important shot length buffer 71 constructs an important shot length storage means.

An important shot playback time calculation unit 72 carries out a process of calculating a playback time duration of the important shot from both the shot length of the important shot which is stored in the important shot length buffer 71, and a preset digest watching time. The important shot playback time calculation unit 72 constructs a playback time calculating means.

Next, the operation of the image digesting apparatus will be explained.

When the shot length calculating unit 2 calculates the shot length of a shot, the important shot determining unit 4 compares the shot length with a preset threshold A, determines whether or not a shot starting from a preceding cut point immediately preceding a cut point detected by the cut point detecting unit 1 is an important shot, and outputs the determination result, like that of above-mentioned Embodiment 1.

In this case, the important shot determining unit 4 detects an important shot in the same way that that of above-mentioned Embodiment 1 does, as mentioned above. The detecting method of detecting an important shot is not limited to the one described in above-mentioned Embodiment 1, and, for example, the method described in either one of above-mentioned Embodiments 2 to 6 can be used.

When receiving a digest watching time PT set up by a user, the important shot playback time calculation unit 72 calculates a playback time duration PSᵢ of the i-th important shot from the digest watching time PT and the shot length SLᵢ of the i-th important shot stored in the important shot length buffer 71 in such a manner that the playback time duration satisfies the following equation.

$$PT = {\sum }_{i = 0}^{m} {PS}_{i} \\ {PS}_{i} = \frac{PT}{m {\sum }_{i = 0}^{m} {SL}_{i}} {SL}_{i} \qquad [ Equation 1 ]$$

where m shows the number of important shots.

As can be seen from the above description, because the image digesting apparatus in accordance with this embodiment 8 is so constructed as to calculate a playback time duration of an important shot from its shot length stored in the important shot length buffer 71 and a preset digest watching time of an important shot, there is provided an advantage of being able to set up a watching time for each important shot at the time of playback of a digest with a weight according to the length of each shot.

### Embodiment 9

FIG. 14 is a block diagram showing an image digesting apparatus in accordance with Embodiment 9 of the present invention. In the figure, because the same reference numerals as those shown in FIG. 1 denote the same components or like components, the explanation of these components will be omitted hereafter.

An important shot determining unit 81 carries out a process of calculating the shot length of a shot starting from each cut point from the detected time of each cut point stored in the shot start point buffer 3 and determining, as a shot to be played back, a shot having a long shot length on a priority basis from among a plurality of shots according to a desired digest watching time. The important shot determining unit 81 constructs an important shot determining means.

Next, the operation of the image digesting apparatus will be explained.

When receiving an image signal, the cut point detecting unit 1 carries out a process of detecting cut points of the image, like that of above-mentioned Embodiment 1.

When detecting a cut point of the image, the cut point detecting unit 1 stores the detected time of the cut point in the shot start point buffer 3.

When the image is ended and the important shot determining unit 81 then receives an image end signal, the important shot determining unit 81 acquires the detected times of cut points from the shot start point buffer 3, and calculates the shot length of a shot starting from each of the cut points from the detected times.

The important shot determining unit 81 then determines the start point and playback time duration of an important shot by determining, as a shot to be played back (an important shot), a shot having a long shot length on a priority basis from among a plurality of shots according to the desired digest watching time.

Concretely, this processing is carried out as follows.

For example, in a case in which the image signal includes m shots, the important shot determining unit 81 acquires the shot length SLᵢ of the i-th shot by using both the time STᵢ of the start point of the i-th shot in the m shots (the detected time of the i-th cut point) and the time STᵢ₊₁ of the start point of the (i+1)-th shot.

SLᵢ=STᵢ₊₁−STᵢ

After acquiring the shot length SLᵢ of each of the m shots included in the image signal as mentioned above, the important shot determining unit 81 sorts the m shots in order of decreasing the shot length SLᵢ.

When each of the sorted shot lengths is expressed as SSLᵢ, the following relationship: SSLᵢ>=SSLᵢ₊₁ is established because they are sorted in order of decreasing the shot length.

The important shot determining unit 81 then multiplies each sorted shot length SSLᵢ by a coefficient α, and calculates the sum total of multiplication results αSSLᵢ, where the coefficient α has a range of 0≦α≦=1.

The important shot determining unit 81 compares the sum total of multiplication results αSSLᵢ with the digest watching time T_{Dijest}, and calculates the largest k that satisfies the following inequality.

$${T}_{Dijest} \geq α {\sum }_{i = 0}^{k} {SSL}_{i} \qquad [ Equation 2 ]$$

After calculating the largest k that satisfies the above-mentioned inequality, the important shot determining unit 81 sets the shot length SSLₖ at that time as a threshold SL_{Th} for shot lengths which is to be used when determining an important shot.

After setting up the threshold SL_{Th} for shot lengths, the important shot determining unit 81 compares the shot length SLᵢ of each of the m shots included in the image signal with the threshold SL_{Th}, certifies that any shot which satisfies SL_{Th}<SLᵢ is an important shot, and determines that the important shot is a shot to be played back.

At this time, the important shot determining unit sets the playback time duration of each shot to be played back to αSLᵢ. As a result, the time period during which a digest is to be played back becomes equal to or less than the digest watching time T_{Dijest}.

As can be seen from the above description, because the image digesting apparatus in accordance with this embodiment 9 is so constructed as to calculate the shot length of a shot starting from each cut point from the detected time of each cut point stored in the shot start point buffer 3, and to determine, as a shot to be played back, a shot having a long shot length on a priority basis from among a plurality of shots according to a desired digest watching time, there is provided an advantage of being able to enable the user to watch and listen to only important shots.

Decreasing the value of the coefficient α results in increase in the number of shots to be played back and hence decrease in the playback time duration per shot. In contrast, increasing the value of the coefficient α results in decrease in the number of shots to be played back and hence increase in the playback time duration per shot.

Therefore, the value of the coefficient α can be used properly according to the genre and features of the image content and the user's request.

As time information, such as a shot length and a shot start point, a time, a frame number, time information in image compressed data, or the like can be used.

### Embodiment 10

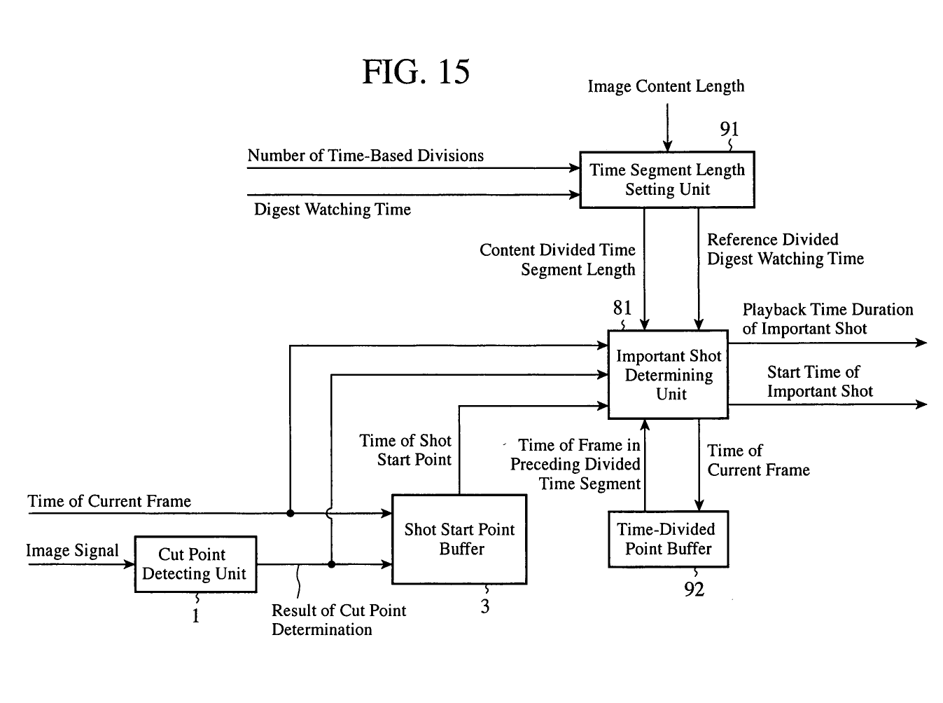

FIG. 15 is a block diagram showing an image digesting apparatus in accordance with Embodiment 10 of the present invention. In the figure, because the same reference numerals as those shown in FIGS. 1 and 14 denote the same components or like components, the explanation of these components will be omitted hereafter.

A time segment length setting unit 91 calculates a content divided time segment length (a time segment length which is used as a reference with which a content is divided into parts each having a time duration equal to the time segment length), and a reference divided digest watching time (a time which is used as a reference with which a digest about a divided time segment is watched and listened to) from an image content length, a desired digest watching time set up by a user, and the number of time-based divisions set up by the user or automatically set up (the number of parts into which a content is divided with respect to time). The time segment length setting unit 91 constructs a time segment length setting means.

The important shot determining unit 81 calculates the shot length of a shot starting from each cut point from the detected time of each cut point stored in the shot start point buffer 3, and determines, as a shot to be played back, a shot having a long shot length on a priority basis from among a plurality of shots according to a desired digest watching time, like the important shot judgment unit 81 shown in FIG. 14. At this time, the important shot determining unit 81 of FIG. 15 calculates the shot length of a shot starting from each cut point from the detected time of each cut point stored in the shot start point buffer 3 at a time defined by the time segment length set up by the time segment length setting unit 91.

A time-divided point buffer 92 is a memory for storing a time at when the content is divided.

Next, the operation of the image digesting apparatus will be explained.

When receiving a digest watching time T_{Dijest}, the number n of time-based divisions of an image content, and an image content length T_{Content} which have been set up by a user, the time segment length setting unit 91 sets up the content divided time segment length T_{Segment} and the reference divided digest watching time T_{S}_{_{—}}_{Dijest} according to those pieces of input information.

T_{Segment}=T_{Content}/n

T_{S}_{_{—}}_{Dijest}=T_{Dijest}/n

For example, in a case in which the image content length T_{Content} is 30 minutes (=1,800 seconds), the digest watching time T_{Dijest} is 5 minutes (=300 seconds), and the number n of time-based divisions of the image content is 10, the content divided time segment length T_{Segment} is set to 3 minutes (=180 seconds) and the reference divided digest watching time T_{S}_{_{—}}_{Dijest} is set to 0.5 minutes (=30 seconds).

When receiving an image signal, the cut point detecting unit 1 carries out a process of detecting cut points of the image, like that of above-mentioned Embodiment 1.

When detecting a cut point of the image, the cut point detecting unit 1 stores the detected time of the cut point in the shot start point buffer 3 and outputs the result of the determination of the cut point to the important shot determining unit 81.

When receiving the result of the determination of the cut point from the cut point detecting unit 1, the important shot determining unit 81 determines the start time of an important shot and the playback time duration of the important shot. Concretely, this processing is carried out as follows.

First, the important shot determining unit 81 refers to both the time T_{Now} of the current frame and the time T_{Pre} of a frame at an immediately preceding divided time which is stored in the time-divided point buffer 92.

When the difference between the time T_{Now} of the current frame and the time T_{Pre} of the frame at the immediately preceding divided time exceeds the content divided time segment length T_{Segment}, as will be shown below, the important shot determining unit 81 refers to the result of the determination of the cut point currently outputted from the cut point detecting unit 1.

T_{segment}<=T_{Now}−T_{Pre}

When the result of the determination of the cut point shows that the current frame is a cut point, the important shot determining unit 81 calculates the i-th divided digest watching time T_{S}_{_{—}}_{Dijest,i} of the image content which is divided into m parts with the cut point being defined as a division point of the image content.

$${T}_{S \_ Dijest , i} = \frac{{T}_{Now} - {T}_{Pre}}{{T}_{Segment}} \times {T}_{S Dijest} \qquad [ Equation 3 ]$$

Because the important shot determining unit 81 can know all of the times of the start points of shots in the i-th divided segment and the number of the times at the time when it knows the (i+1)-th division point, the important shot determining unit 81 assumes that this i-th segment has n shots. The important shot determining unit acquires the shot length SL_{i,j} of the j-th shot by using both the time ST_{i,j} of the start point of the j-th shot in these n shots and the time ST_{i,j+1} of the start point of the (j+1)-th shot in the n shots.

SL_{i,j}=ST_{i,j+1}−ST_{i,j}

When calculating the shot length SL_{i,j} of each of the n shots in the image in the divided segment in the mentioned-above way, the important shot determining unit 81 sorts the n shots in such a manner that they are aligned in order of decreasing the shot length SL_{i,j.}

Because the important shot determining unit thus sorts the n shots in such a manner that they are aligned in order of decreasing the shot length, the following relationship: SSL_{i,j}>=SSL_{i,j+1} is established when the sorted shot length is expressed as SSL_{i,j.}

The important shot determining unit 81 then multiplies each sorted shot length SSL_{i,j} by a coefficient α, and calculates the sum total of multiplication results αSSL_{i,j}, where the coefficient α has a range of 0<α<=1.

The important shot determining unit 81 compares the sum total of multiplication results αSSL_{i,j} with the divided digest watching time T_{S}_{_{—}}_{Dijest,i} and calculates the largest k that satisfies the following inequality.

$${T}_{S \_ Dijest , i} \geq α {\sum }_{j = 0}^{k} {SSL}_{i , j} \qquad [ Equation 4 ]$$

After calculating the largest k that satisfies the above-mentioned inequality, the important shot determining unit 81 sets the shot length SSL_{i,k} at that time as a threshold SL_{Th,i} for shot lengths which is to be used when determining an important shot for the i-th segment.

After setting up the threshold SL_{Th,i} for shot lengths, the important shot determining unit 81 compares the shot length SL_{i,j} of each of the n shots included in the image signal with the threshold SL_{Th,i}, certifies that any shot which satisfies SL_{Th,i}<SL_{i,j} is an important shot, and determines that the important shot is a shot to be played back.

At this time, the important shot determining unit sets the playback time duration of each shot to be played back to αSL_{i,j}. As a result, the time period during which a digest in each divided image is to be played back becomes equal to or less than T_{S}_{_{—}}_{Dijest,i}.

If the value of the coefficient α is decreased, the number of shots to be played back increases and therefore the playback time duration per shot becomes short. In contrast with this, if the value of the coefficient α is increased, the number of shots to be played back decreases and therefore the playback time duration per shot becomes long.

In this Embodiment 10, the value of the coefficient α can be varied for each divided segment.

For example, there can be such a usage as to increase the coefficient α for a top news included in a news content in a first half of a program so that the user can watch and listen to a portion which can be assumed to be the most important for a long time, whereas to increase the coefficient α for a consecutive part of a short news in a second half so that the user can watch and listen to an outline of the short news.

In the case of above-mentioned Embodiment 9, the amount of computations required to sort the shot lengths of the whole content may become huge when the content is very long. In contrast, in accordance with this Embodiment 10, because the sorting of the shot lengths has only to be carried out only for the i-th segment, even when the content is very long, the amount of computations required to sort the shot lengths can be prevented from becoming huge and therefore the user is enabled to watch and listen to only important shots.

As time information, such as a shot length and a shot start point, a time, a frame number, time information in image compressed data, or the like can be used.

### Embodiment 11

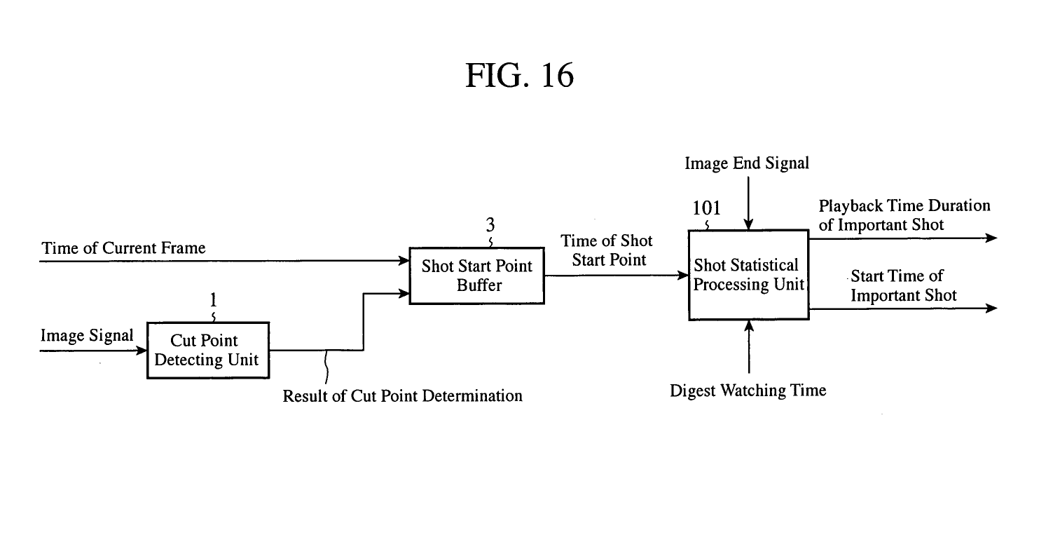

FIG. 16 is a block diagram showing an image digesting apparatus in accordance with Embodiment 11 of the present invention. In the figure, because the same reference numerals as those shown in FIG. 1 denote the same components or like components, the explanation of these components will be omitted hereafter.

A shot statistical processing unit 101 carries out a process of calculating the shot length of a shot starting from each cut point from times stored in the shot start point buffer 3, acquiring a statistical distribution function about the shot length, and determining a shot to be played back from among a plurality of shots according to a desired digest watching time and on the basis of the above-mentioned distribution function. The shot statistical processing unit 101 constructs an important shot determining means.

Next, the operation of the image digesting apparatus will be explained.

When receiving an image signal, the cut point detecting unit 1 carries out a process of detecting cut points of the image, like that of above-mentioned Embodiment 1.

When detecting a cut point of the image, the cut point detecting unit 1 stores the detected time of the cut point in the shot start point buffer 3.

When the image is ended and then receiving an image end signal, the shot statistical processing unit 101 acquires the detected time of each cut point from the shot start point buffer 3, calculates the shot length of a shot starting from each cut point from the detected time, and acquires a statistical distribution function about the shot length.

The shot statistical processing unit 101 then determines a shot to be played back (an important shot) from among a plurality of shots according to a desired digest watching time and on the basis of the above-mentioned distribution function so as to determine the start point and playback time duration of the important shot.

Concretely, this processing is carried out as follows.

In a case in which, for example, there are m shots in the image signal, the shot statistical processing unit 101 acquires the shot length SLᵢ of the i-th shot by using both the time STᵢ of the start point of the i-th shot in the m shots and the time STᵢ₊₁ of the start point of the (i+1)-th shots in the m shots.

SLᵢ=STᵢ₊₁−STᵢ

When the shot statistical processing unit 101 acquires the shot length SLᵢ of each of the m shots included in the image signal in the above-mentioned way, the shot statistical processing unit assumes that the shot length SLᵢ satisfies SLᵢ>0 and the shot length SLᵢ follows a log normal distribution.

At this time, a probability p(x) that the shot length SLᵢ is x, i.e., a distribution probability p(x) is given by the following equation:

$$p ( x ) = \frac{1}{\sqrt{2 π} σ x} exp \{ \frac{- {( ln x - μ )}^{2}}{2 {σ}^{2}} \} \qquad [ Equation 5 ]$$

where μ is the average of SLᵢ and σ² is the variance of SLᵢ.

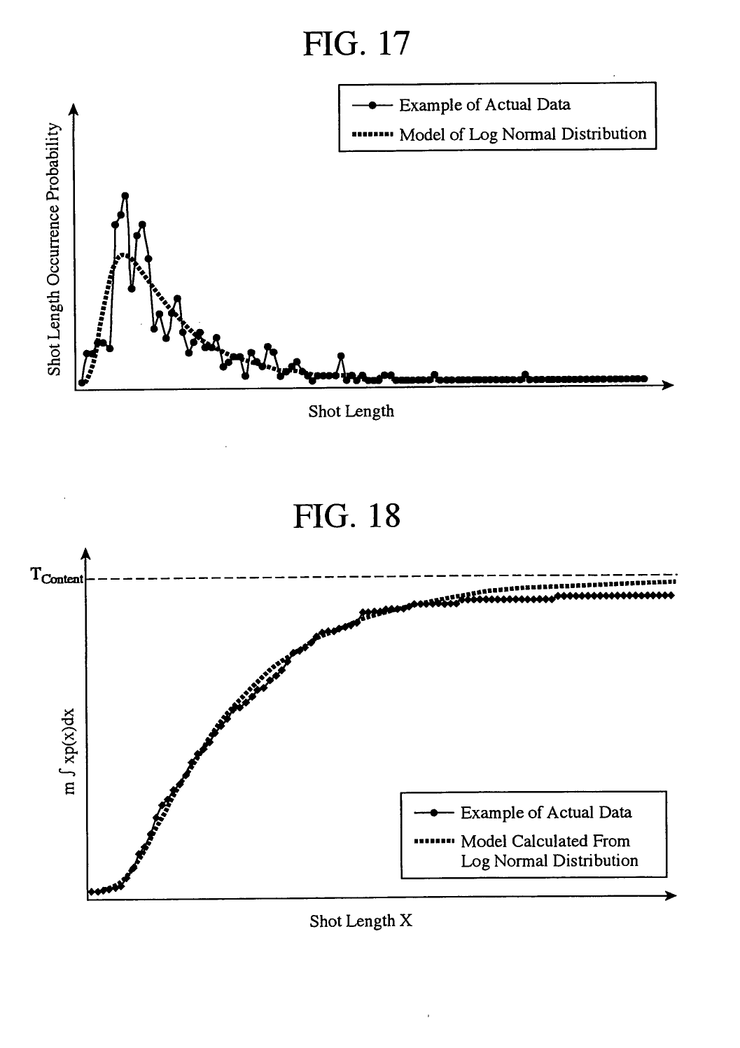

FIG. 17 is an explanatory drawing showing the log normal distribution of the shot length.

The average μ and the variance σ² in the above equation can be easily calculated from the shot length SLᵢ.

Since the length of the image content is expressed as T_{Content}, the distribution probability p(x) can be given by the following equation:

$${\int }_{0}^{∞} p ( x ) d x = {\int }_{0}^{{T}_{Contentn}} p ( x ) d x = 1 \qquad [ Equation 6 ]$$

Because the number of the shots in the image is m, the number of shots whose length is x in the image is given by m×p(x). Therefore, a relation between this probability distribution p(x) and the image content length T_{Content} is shown by the following equation:

$${T}_{Content} = m {\int }_{0}^{{T}_{Content}} xp ( x ) d x \qquad [ Equation 7 ]$$

FIG. 18 is an explanatory drawing showing a relation between the shot length and the image content length T_{content}.

From this relation, assuming 0≦α≦=1, a minimum x₀ that satisfies the following inequality can be calculated on a computer.

$${T}_{Dijest} \geq α m {\int }_{{x}_{0}}^{{T}_{Content}} xp ( x ) d x \qquad [ Equation 8 ]$$

When calculating the minimum x₀ that satisfies the above-mentioned inequality, the shot statistical processing unit 101 sets the minimum x₀ as a threshold SL_{Th} for shot lengths which is used when determining an important shot.

When setting up the threshold SL_{Th} for shot lengths, the shot statistical processing unit 101 compares the shot length SLᵢ of each of the m shots included in the image signal with the threshold SL_{Th}, certifies that any shot which satisfies SL_{Th}<SLᵢ is an important shot, and determines the important shot as a shot to be played back.

At this time, the playback time duration of the shot to be played back is set to αSLᵢ. As a result, the time period during which the digest is to be played back becomes about the digest watching time T_{Dijest}. If the difference between an actual distribution of shot lengths and the assumed probability distribution p(x) is large, the time period can be corrected.

In this Embodiment 11, the average μ and the variance σ² which are used for the statistical processing are calculated after the image content is ended. As an alternative, for example, every time when a cut point is detected, the μi of the shot lengths of shots including up to the i-th shot can be calculated sequentially and can be updated using the following equation:

μᵢ=(SLᵢ+(i−1)μᵢ₋₁)i

Similarly, the variance σ² can be calculated sequentially in a similar calculation way and can be updated. A certain rough calculation can be alternatively used.

Furthermore, a log normal distribution is used as the distribution function in this Embodiment 11.

As an alternative, another distribution function such as a normal distribution can be used.

If the value of the coefficient α is decreased, the number of shots to be played back increases and therefore the playback time duration per shot becomes short. In contrast with this, if the value of the coefficient α is increased, the number of shots to be played back decreases and therefore the playback time duration per shot becomes long.

It is therefore preferable to change the value of the coefficient α properly according to the genre or characteristics of the content, or the user's request.

Therefore, the use of this Embodiment 11 makes it possible to change the accuracy of the statistical processing according to the capability of a computer to be used. Also in a case in which the present embodiment is applied to mobile equipment or the like, the user is enabled to watch and listen to only important shots.

As time information, such as a shot length and a shot start point, a time, a frame number, time information in image compressed data, or the like can be used.

### Embodiment 12

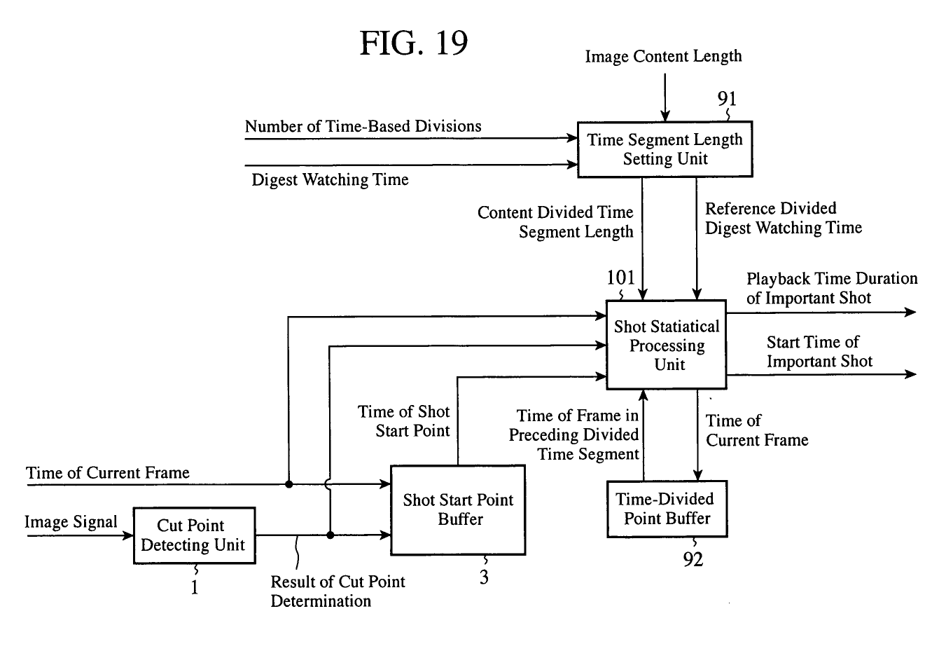

FIG. 19 is a block diagram showing an image digesting apparatus in accordance with Embodiment 12 of the present invention. In the figure, because the same reference numerals as those shown in FIGS. 15 and 16 denote the same components or like components, the explanation of these components will be omitted hereafter.

Next, the operation of the image digesting apparatus will be explained.

When receiving a digest watching time T_{Dijest}, the number n of time-based divisions of an image content, and an image content length T_{Content} which have been set up by a user, the time segment length setting unit 91 sets up a content divided time segment T_{Segment} and a reference divided digest watching time T_{S}_{_{—}}_{Dijest} according to those pieces of input information.

T_{Segment}=T_{Content}/n

T_{S}_{_{—}}_{Dijest}=T_{Dijest}/n

For example, in a case in which the image content length T_{Content} is 30 minutes (=1,800 seconds), the digest watching time T_{Dijest} is 5 minutes (=300 seconds), and the number n of time-based divisions of the image content is 10, the content divided time segment T_{Segment} is set to 3 minutes (=180 seconds) and the reference divided digest watching time T_{S}_{_{—}}_{Dijest} is set to 0.5 minutes (=30 seconds).

When receiving an image signal, the cut point detecting unit 1 carries out a process of detecting cut points of the image, like that of above-mentioned Embodiment 1.

When detecting a cut point of the image, the cut point detecting unit 1 stores the detected time of the cut point in the shot start point buffer 3 and outputs the result of the determination of the cut point to the shot statistical processing unit 101.

When receiving the result of the determination of the cut point from the cut point detecting unit 1, the shot statistical processing unit 101 determines the start time of an important shot and the playback time duration of the important shot.

Concretely, this processing is carried out as follows.

First, the shot statistical processing unit 101 refers to the time T_{Now} of a current frame and the time T_{Pre} of a frame at an immediately preceding divided time which is stored in the time-divided point buffer 92.

When the difference between the time T_{Now} of the current frame and the time T_{Pre} of the frame at the immediately preceding divided time exceeds the content divided time segment length T_{Segment}, as will be shown below, the shot statistical processing unit 101 refers to the result of the determination of the cut point currently outputted from the cut point detecting unit 1.

T_{segment}<=T_{Now}−T_{Pre}

When the result of the determination of the cut point shows that the current frame is a cut point, the shot statistical processing unit 101 calculates the i-th divided digest watching time T_{S}_{_{—}}_{Dijest,i} of the image content which is divided into m parts with the cut point being defined as a division point of the image content. The shot statistical processing unit also calculates the length T_{Segment,i} of the i-th segment.

$${T}_{S \_ Dijest , i} = \frac{{T}_{Now} - {T}_{Pre}}{{T}_{Segment}} \times {T}_{S Dijest} \\ {T}_{Segment , i} = {T}_{Now} - {T}_{Pre} \qquad [ Equation 9 ]$$

Because the shot statistical processing unit 101 can know all of the times of the start points of shots in the i-th divided segment and the number of the times at the time when it has known the (i+1)-th division point, the shot statistical processing unit 101 assumes that this i-th segment has n shots. The shot statistical processing unit then acquires the shot length SL_{i,j} of the j-th shot by using both the time ST_{i,j} of the start point of the j-th shot in these n shots and the time ST_{i,j+1} of the start point of the (j+1)-th shot in the n shots.

SL_{i,j}=ST_{i,j+1}−ST_{i,j}

When acquiring the shot length SLᵢ of each of the n shots included in the image signal in the mentioned-above way, the shot statistical processing unit 101 assumes that the shot length SLᵢ satisfies SLᵢ>0 and the shot length SLᵢ follows a log normal distribution, like that of above-mentioned Embodiment 11.

At this time, a probability p(x) that the shot length SLᵢ is x, i.e., a distribution probability p(x) is given by the following equation:

$$p ( x ) = \frac{1}{\sqrt{2 π} σ x} exp \{ \frac{- {( ln x - μ )}^{2}}{2 {σ}^{2}} \} \qquad [ Equation 10 ]$$

where μ is the average of SLᵢ and σ² is the variance of SLᵢ.

Since the length of this i-th segment is expressed as T_{Segment,i}, the distribution probability p(x) can be given by the following equation:

$${\int }_{0}^{∞} p ( x ) d x = {\int }_{0}^{{T}_{Segment , j}} p ( x ) d x = 1 \qquad [ Equation 11 ]$$

Because the number of the shots in the image is n, the number of shots whose length is x in the image is given by n×p(x). Therefore, a relation between this probability distribution p(x) and the image content length T_{Content} is shown by the following equation:

$${T}_{Segment , i} = n {\int }_{0}^{{T}_{Segment , i}} xp ( x ) d x \qquad [ Equation 12 ]$$

From this relation, assuming 0<α<=1, a minimum x₀ that satisfies the following inequality can be calculated on a computer.

$${T}_{S Dijest , i} \geq α n {\int }_{{x}_{0}}^{{T}_{Segment , j}} xp ( x ) d x \qquad [ Equation 13 ]$$

When calculating the minimum x₀ that satisfies the above-mentioned inequality, the shot statistical processing unit 101 sets the minimum x0 as a threshold SL_{Th,i} for shot lengths which is used when determining an important shot.

When setting up the threshold SL_{Th,i} for shot lengths, the shot statistical processing unit 101 compares the shot length SL_{i,j} of each of the n shots included in the image signal with the threshold SL_{Th,i}, certifies that any shot which satisfies SL_{Th,i}<SL_{i,j} is an important shot, and determines the important shot as a shot to be played back.

At this time, the shot statistical processing unit sets the playback time duration of the shot to be played back to αSL_{i,j}. As a result, the time period during which the digest is to be played back becomes about the divided digest watching time T_{S}_{_{—}}_{Dijest,i}. If the difference between an actual distribution of shot lengths and the assumed probability distribution p(x) is large, the time period can be corrected.

In this Embodiment 12, the average μ and the variance σ² which are used for the statistical processing are calculated after the image content is ended. As an alternative, for example, every time when a cut point is detected, the average μ_{i,j} of the shot lengths of shots including up to the j-th shot in the i-th segment can be calculated sequentially and can be updated using the following equation:

μ_{i,j}=(SL_{i,j}+(j−1)μ_{i,j-1})/j

Similarly, the variance σ² can be calculated sequentially in a similar calculation way and can be updated.

A certain rough calculation can be alternatively used.

Furthermore, a log normal distribution is used as the distribution function in this Embodiment 12. As an alternative, another distribution function such as a normal distribution can be used.

If the value of the coefficient α is decreased, the number of shots to be played back increases and therefore the playback time duration per shot becomes short. In contrast with this, if the value of the coefficient α is increased, the number of shots to be played back decreases and therefore the playback time duration per shot becomes long.

In this Embodiment 12, the value of the coefficient α can be varied for each divided segment.

For example, there can be such a usage as to increase the coefficient α for a top news included in a news content in a first half of a program so that the user can watch and listen to a portion which can be assumed to be the most important for a long time, whereas to increase the coefficient α for a consecutive part of a short news in a second half so that the user can watch and listen to an outline of the short news.

Even in a case in which this Embodiment 12 is applied to a computer having poor throughput, such as mobile equipment, and a very long content is processed by the computer, by adjusting the accuracy of the dividing processing and that of the statistical processing, the user is enabled to watch and listen to only important shots.

As time information, such as a shot length and a shot start point, a time, a frame number, time information in image compressed data, or the like can be used.

### Embodiment 13

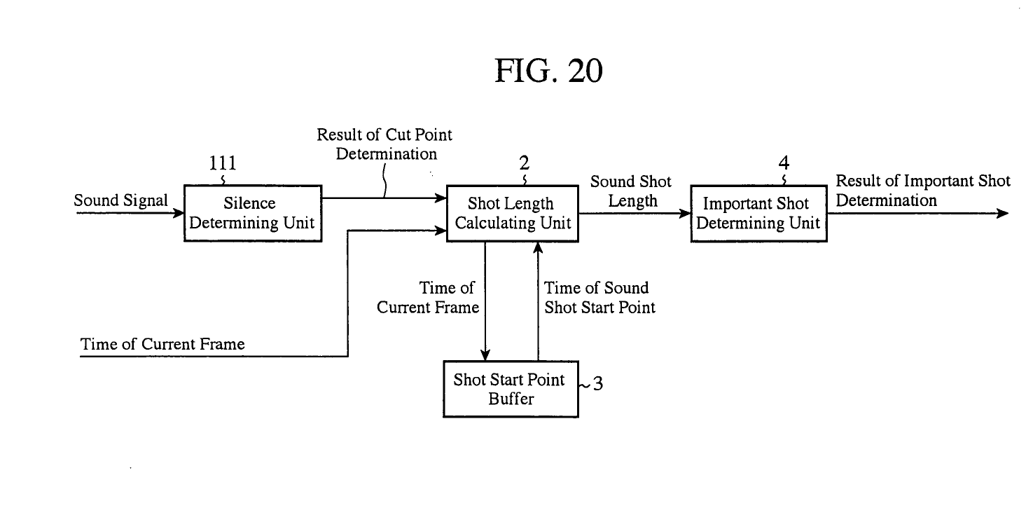

FIG. 20 is a block diagram showing an image digesting apparatus in accordance with Embodiment 13 of the present invention. In the figure, because the same reference numerals as those shown in FIG. 1 denote the same components or like components, the explanation of these components will be omitted hereafter.

A silence determining unit 111 carries out a process of determining whether or not a sound signal in an image is silent so as to detect a silent point of the sound in the image. The silence determining unit 111 constructs a silent point detecting means.

Next, the operation of the image digesting apparatus will be explained.

The silence determining unit 111 determines whether or not a sound signal in an image is silent so as to detect a silent point of the sound in the image.

When detecting a silent point of the sound in the image, the silence determining unit 111 assumes that the silent point is a cut point and then outputs the detection result to the shot length calculating unit 2 as the result of the determination of a cut point.

As a detecting method of detecting a silent point, for example, a method of comparing the sound volume with a threshold can be considered. Another method can be alternatively used.

When the result of the determination of a cut point outputted from the silence determining unit 111 shows that a current frame is not a cut point, the shot length calculating unit 2 does not carry out any processing especially, whereas when the result of the determination of a cut point outputted from the silence determining unit shows that the current frame is a cut point, the shot length calculating unit 2 calculates the time difference between the time of the current frame and the time of the shot start point of an immediately preceding shot stored in the shot start point buffer 3 and outputs, as the shot length, the time difference to the important shot determining unit 4, like that of above-mentioned Embodiment 1.

The shot length calculating unit 2 replaces the memory content of the shot start point buffer 3 with the time of the current frame after calculating the shot length.

After the shot length calculating unit 2 calculates the shot length, the important shot determining unit 4 compares the shot length with a preset threshold A, like that of above-mentioned Embodiment 1.

When the shot length is longer than the preset threshold A, the important shot determining unit 4 then determines that a shot starting from a preceding silent point (a cut point) immediately preceding the silent point (the cut point) currently detected by the silence determining unit 111 is an important shot, and outputs the result of the determination.

In this case, the important shot determining unit 4 determines that the shot starting from the immediately preceding cut point is an important shot. As an alternative, the important shot determining unit can determine that a next shot next to the shot starting from the immediately preceding cut point is an important shot, or can determine that both the shot starting from the immediately preceding cut point and the next shot are important shots.

Because the image digesting apparatus according to this Embodiment 13 assumes that a silent point of the sound signal, other than a change point in the image, is a cut point of the image content, the user can watch and listen to only a long word or a narration which is important in a story of either a drama or a film content, or a musical piece of a musical program. Furthermore, the unnaturalness at a time of watching and listening to important shots continuously can be reduced by using silent points.

The image digesting apparatus according to this Embodiment 13 can be applied not to an image content, but to a content including only sounds, such as a radio broadcast program.

As time information, such as a shot length and a shot start point, a time, a frame number, time information in image compressed data, or the like can be used.

### Embodiment 14

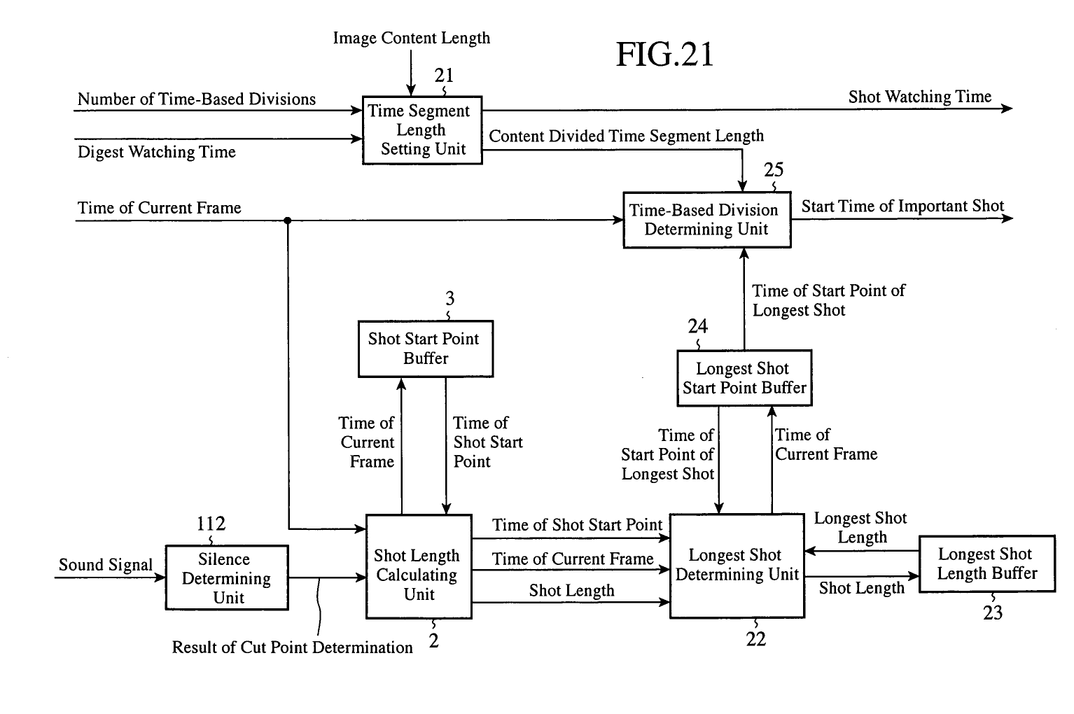

FIG. 21 is a block diagram showing an image digesting apparatus in accordance with Embodiment 14 of the present invention. In the figure, because the same reference numerals as those shown in FIG. 5 denote the same components or like components, the explanation of these components will be omitted hereafter.

A sound volume determining unit 112 carries out a process of comparing the sound volume of a sound signal in an image with a threshold so as to detect a sound volume decrease point whose sound volume in the sound signal is smaller than the threshold. The sound volume determining unit 112 constructs a sound volume decrease point detecting means.

Next, the operation of the image digesting apparatus will be explained.

When receiving a digest watching time T_{Dijest}, the number n of time-based divisions of an image content, and an image content length T_{Content} which have been set up by a user, the time segment length setting unit 21 sets up the number Nₛₕₒₜ of important shots to be extracted, the content divided time segment T_{Segment}, and the shot watching time T_{Play} according to those pieces of input information.

Nₛₕₒₜ=n

T_{Segment}=T_{Content}/n

T_{Play}=T_{Dijest}/n

In the case in which the time segment length setting unit sets up the parameters in this way, the user will watch and listen to only a T_{Play}-second head part of each of n shots.

For example, in a case in which the image content length T_{Content} is 30 minutes (=1,800 seconds), the digest watching time T_{Dijest} is 5 minutes (=300 seconds), and the number n of time-based divisions of the image content is 10, the content divided time segment length T_{Segment} is set to 3 minutes (=180 seconds) and the shot watching time T_{Play} is set to 0.5 minutes (=30 seconds).

As an alternative, the time segment length setting unit 21 can input, instead of the numerical information, information expressed in words, and analyze the words so as to determine the digest watching time T_{Dijest}, the number n of time-based divisions of the image content, and the image content length T_{Content}.

When inputting a sound signal in an image, the sound volume determining unit 112 compares the sound volume of the sound signal with the preset threshold so as to detect a sound volume decrease point whose sound volume of the sound signal is smaller than the threshold.

The sound volume determining unit 112 does not assume that any point at which the sound volume of the sound signal is larger than the threshold is a cut point, but assumes that a sound volume decrease point whose sound volume of the sound signal is smaller than the threshold is a cut point, and outputs the result of the detection to the shot length calculating unit 2 as the result of the determination of a cut point.

This threshold can be varied according to the genre of the content. For example, if the content is a sports live broadcast program, the sound volume determining unit sets the threshold to a larger value so as to detect whether or not a cheer is included in the sound signal. As an alternative, if the content is a news program or a musical program, the sound volume determining unit lowers the threshold to a level close to a noise level so as to detect a silent part such as a break point of a caster or reporter's talk, or a break point of a musical piece.

When the result of the cut point determination outputted from the sound volume determining unit 112 shows that the frame is not a cut point, the shot length calculating unit 2 does not carry out any processing especially, whereas when the result of the cut point determination outputted from the sound volume determining unit shows that the frame is a cut point, the shot length calculating unit 2 calculates the time difference between the time of the current frame and the time of the shot start point of an immediately preceding shot stored in the shot start point buffer 3 and outputs, as the shot length, the time difference to the important shot determining unit 4, like that of above-mentioned Embodiment 1.

The shot length calculating unit 2 replaces the memory content of the shot start point buffer 3 with the time of the current frame after calculating the shot length.

Every time when the shot length calculating unit 2 calculates a shot length, the longest shot determining unit 22 compares shot lengths which have been calculated by the shot length calculating unit 2 with one another so as to determine a shot having the longest shot length, like that of above-mentioned Embodiment 2.

More specifically, after the shot length calculating unit 2 calculates a shot length, the longest shot determining unit 22 compares the shot length currently calculated by the shot length calculating unit 2 with the shot length of the longest shot stored in the longest shot length buffer 23, and, when the shot length currently calculated by the shot length calculating unit 2 is longer than the shot length of the longest shot stored in the longest shot length buffer 23, determines that the shot whose shot length is currently calculated by the shot length calculating unit 2 is the longest shot at present.

After determining the longest shot at present, the longest shot determining unit 22 replaces the memory content of the longest shot length buffer 23 with the shot length currently calculated by the shot length calculating unit 2.

The longest shot determining unit 22 also replaces the memory content of the longest shot start point buffer 24 with the time of the start point of the longest shot (the time of the current frame).

The time-based division determining unit 25 outputs the time of the start point of the important shot at a time defined by the content divided time segment T_{Segment} set up by the time segment length setting unit 21, like that of above-mentioned Embodiment 2.

More specifically, when the time of the current frame is an integral multiple of the content divided time segment length T_{Segment} set up by the time segment length setting unit 21, the time-based division determining unit 25 carries out a process of outputting the start time of the longest shot stored in the longest shot start point buffer 24 as the start time of the important shot which is used for playback of a digest.

In this embodiment, the time-based division determining unit 25 outputs the time of the start point of the longest shot, as mentioned above. As an alternative, the time-based division determining unit can output either the time of the start point of the next shot next to the longest shot or both the time of the start point of the longest shot and that of the next shot.

In this case, a buffer for storing the time of the start point of the next shot next to the longest shot needs to be disposed.

As can be seen from the above description, the image digesting apparatus in accordance with this embodiment 14 discriminates shots on the basis of the sound volume, and, every time when the shot length calculating unit 2 calculates a shot length, compares shot lengths which have been calculated by the shot length calculating unit 2 with one another, and detects a shot having the longest shot length at a time defined by a time segment length set up by the time segment length setting unit 21. Therefore, the present embodiment offers an advantage of making it possible for the user to grasp important shots easily without causing any increase in the calculation load by carrying out a very complicated process, such as a process based on either one of a variety of image processing methods and sound processing methods.

In a case in which this Embodiment 14 is applied to a recording apparatus, a sound recording system, or a playback apparatus, because the start time and shot playback time duration of an important shot of an image on the basis of the sound volume are known, automatic editing of the image and simple watching and listening of playback of a digest of the image can be implemented. The unnaturalness at a time of watching and listening to important shots continuously can be reduced by using portions with a small sound volume.

The image digesting apparatus according to this Embodiment 14 can be applied not to an image content, but to a content including only sounds, such as a radio broadcast program.

As time information, such as a shot length and a shot start point, a time, a frame number, time information in image compressed data, or the like can be used.

### Embodiment 15

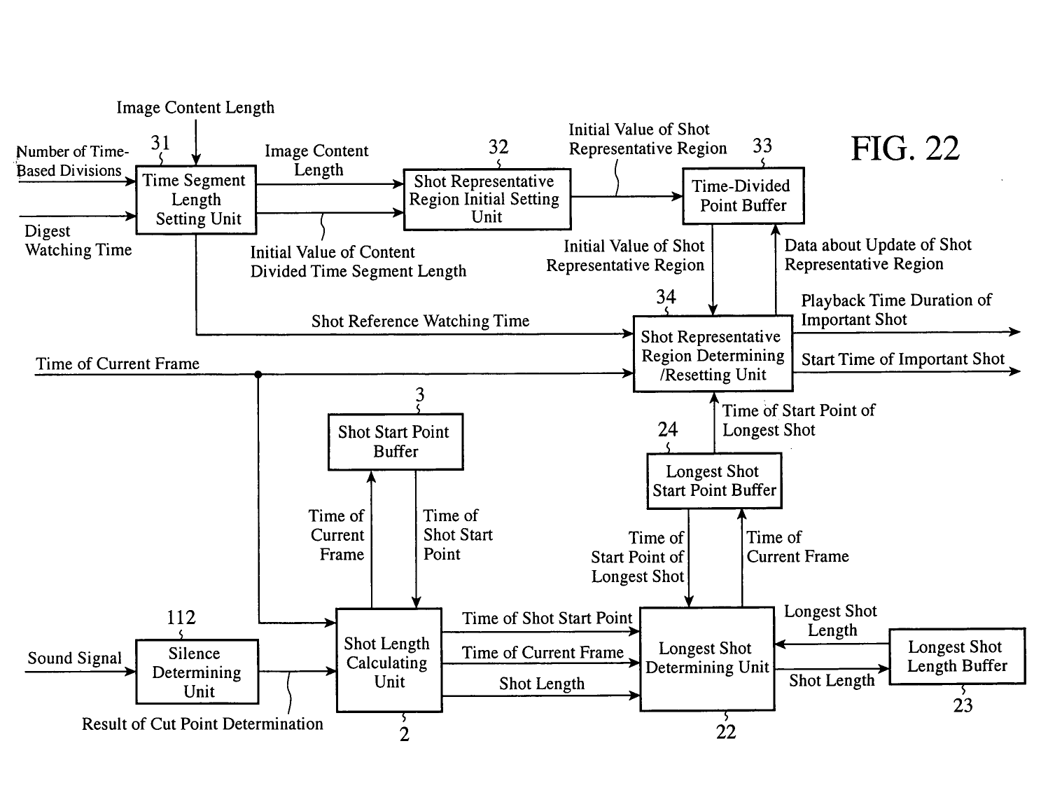

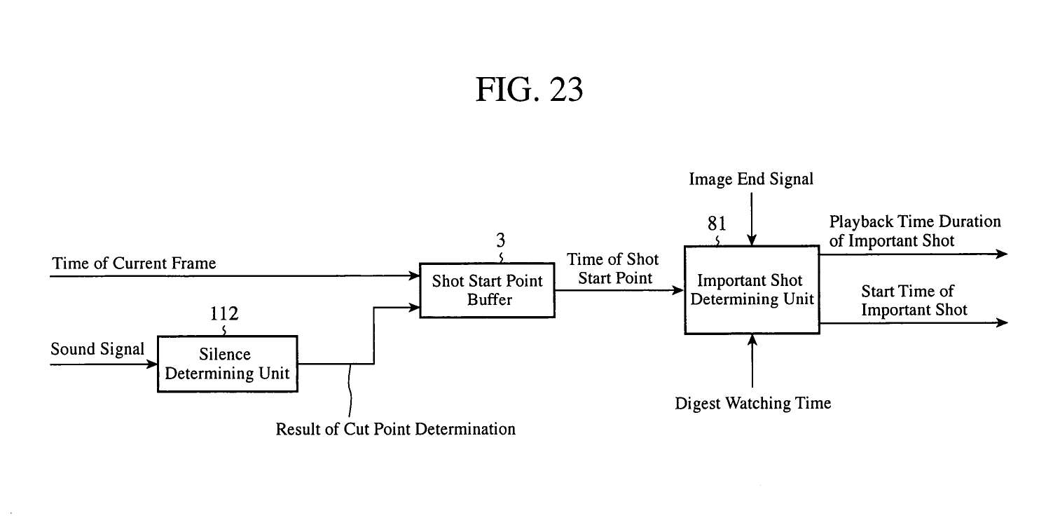

FIG. 22 is a block diagram showing an image digesting apparatus in accordance with Embodiment 15 of the present invention. In the figure, because the same reference numerals as those shown in FIGS. 6 and 21 denote the same components or like components, the explanation of these components will be omitted hereafter.

Next, the operation of the image digesting apparatus will be explained.

When receiving a digest watching time T_{Dijest}, the number n of time-based divisions of an image content, and an image content length T_{Content} which have been set up by a user, the time segment length setting unit 31 sets up the number Nₛₕₒₜ of important shots to be extracted, the initial value T_{Segment0} of the content divided time segment length, and the shot reference watching time T_{Play0} according to those pieces of input information.

Nₛₕₒₜ=n

T_{Segment0}=T_{Content}/n

T_{Play0}=T_{Dijest}/n

For example, in a case in which the image content length T_{Content} is 30 minutes (=1,800 seconds), the digest watching time T_{Dijest} is 5 minutes (=300 seconds), and the number n of time-based divisions of the image content is 10, the initial value T_{Segment0} of the content divided time segment length is set to 3 minutes (=180 seconds) and the shot reference watching time T_{Play0} is set to 0.5 minutes (=30 seconds).

As an alternative, the time segment length setting unit 31 can input, instead of the numerical information, information expressed in words, and analyze the words so as to determine the digest watching time T_{Dijest}, the number n of time-based divisions of the image content, and the image content length T_{Content}.

After the time segment length setting unit 31 sets up the initial value T_{Segment0} of the content divided time segment length, the shot representative region initial setting unit 32 sets up an initial value of a shot representative region (the start point P_{Start} of the shot representative region and the end point P_{End}_{_{—}}ₜₑₘₚ of a temporary shot representative region) from the initial value T_{Segment0} of the content divided time segment length and the image content length T_{content}, like that of above-mentioned Embodiment 3.

P_{Start}=0

P_{End}_{_{—}}ₜₑₘₚ=T_{Content}/Nₛₕₒₜ=T_{Segment0}

After setting up the initial value of the shot representative region, the shot representative region initial setting unit 32 stores the initial value of the shot representative region in the time-divided point buffer 33.

When inputting a sound signal in an image, the sound volume determining unit 112 compares the sound volume of the sound signal with a preset threshold so as to detect a sound volume decrease point whose sound volume of the sound signal is smaller than the threshold, like that of above-mentioned Embodiment 14.

The sound volume determining unit 112 does not assume that any point at which the sound volume of the sound signal is larger than the threshold is a cut point, but assumes that a sound volume decrease point whose sound volume of the sound signal is smaller than the threshold is a cut point, and outputs the result of the detection to the shot length calculating unit 2 as the result of the cut point determination.

This threshold can be varied according to the genre of the content. For example, if the content is a sports live broadcast program, the sound volume determining unit sets the threshold to a larger value so as to detect whether or not a cheer is included in the sound signal. As an alternative, if the content is a news program or a musical program, the sound volume determining unit lowers the threshold to a level close to a noise level so as to detect a silent part such as a break point of a caster or reporter's talk, or a break point of a musical piece.

When the result of the cut point determination outputted from the sound volume determining unit 112 shows that the current frame is not a cut point, the shot length calculating unit 2 does not carry out any processing especially, whereas when the result of the cut point determination outputted from the sound volume determining unit shows that the current frame is a cut point, the shot length calculating unit 2 calculates the time difference between the time of the current frame and the time of the shot start point of an immediately preceding shot stored in the shot start point buffer 3 and outputs, as the shot length, the time difference to the important shot determining unit 4, like that of above-mentioned Embodiment 1.

The shot length calculating unit 2 replaces the memory content of the shot start point buffer 3 with the time of the current frame after calculating the shot length.

Every time when the shot length calculating unit 2 calculates a shot length, the longest shot determining unit 22 compares shot lengths which have been calculated by the shot length calculating unit 2 with one another so as to determine a shot having the longest shot length, like that of above-mentioned Embodiment 2.

More specifically, after the shot length calculating unit 2 calculates a shot length, the longest shot determining unit 22 compares the shot length currently calculated by the shot length calculating unit 2 with the shot length of the longest shot stored in the longest shot length buffer 23, and, when the shot length currently calculated by the shot length calculating unit 2 is longer than the shot length of the longest shot stored in the longest shot length buffer 23, determines that the shot whose shot length is currently calculated by the shot length calculating unit 2 is the longest shot at present.

After determining the longest shot at present, the longest shot determining unit 22 replaces the memory content of the longest shot length buffer 23 with the shot length currently calculated by the shot length calculating unit 2.

The longest shot determining unit 22 also replaces the memory content of the longest shot start point buffer 24 with the time of the start point of the longest shot (the time of the current frame).

When the time P_{Now} of the current frame exceeds the end point P_{End}_{_{—}}ₜₑₘₚ of the temporary shot representative region stored in the time-divided point buffer 33, the shot representative region determining/resetting unit 34 calculates the end point P_{End} of the shot representative region and the important shot playback time duration T_{Play} and outputs the important shot playback time duration T_{Play}, like that of above-mentioned Embodiment 3.

P_{End}=P_{Now}+P_{Shot}_{_{—}}_{Start}−P_{Start}

T_{Play}=(P_{End}−P_{Start})*T_{play0}/T_{Segment0}

where P_{Shot}_{_{—}}ₛₜₐᵣₜ is the start time of the longest shot which is stored in the longest shot start point buffer 24.

Furthermore, when the time P_{Now} of the current frame exceeds the end point P_{End}_{_{—}}ₜₑₘₚ of the temporary shot representative region stored in the time-divided point buffer 33, the shot representative region determining/resetting unit 54 outputs the time P_{Shot}_{_{—}}ₛₜₐᵣₜ of the start point of the longest shot which is stored in the longest shot start point buffer 24 as the start time of an important shot which is used for playback of a digest, and updates the start point P_{Start} of the shot representative region and the end point P_{End}_{_{—}}ₜₑₘₚ of the temporary shot representative region which are stored in the time-divided point buffer 33.

The updated shot representative region is given as follows.

P_{Start}=P_{End}

P_{End}_{_{—}}ₜₑₘₚ=P_{End}+T_{Content}/Nₛₕₒₜ=P_{End}+T_{segment0}

As can be seen from the above description, because the image digesting apparatus in accordance with this embodiment 15 is so constructed as to update the shot representative region according to the start time of the longest shot determined by the longest shot determining unit 22 and the shot length by discriminating shots on the basis of the sound volume, there is provided an advantage of making it possible to change breakpoints of the content and the playback time duration of an important shot in a divided part of the content adaptively.

The unnaturalness at a time of watching and listening to important shots continuously can be reduced by using portions with a small sound volume.

The image digesting apparatus according to this Embodiment 15 can be applied not to an image content, but to a content including only sounds, such as a radio broadcast program.

As time information, such as a shot length and a shot start point, a time, a frame number, time information in image compressed data, or the like can be used.

### Embodiment 16

FIG. 23 is a block diagram showing an image digesting apparatus in accordance with Embodiment 16 of the present invention. In the figure, because the same reference numerals as those shown in FIGS. 14 and 21 denote the same components or like components, the explanation of these components will be omitted hereafter.

Next, the operation of the image digesting apparatus will be explained.

When inputting a sound signal in an image, the sound volume determining unit 112 compares the sound volume of the sound signal with a preset threshold so as to detect a sound volume decrease point whose sound volume of the sound signal is smaller than the threshold, like that of above-mentioned Embodiment 14.

The sound volume determining unit 112 does not assume that any point at which the sound volume of the sound signal is larger than the threshold is a cut point, but assumes that a sound volume decrease point whose sound volume of the sound signal is smaller than the threshold is a cut point, and outputs the result of the detection to the shot start point buffer 3 as the result of the cut point determination.

Furthermore, when detecting a sound volume decrease point, the sound volume determining unit stores the detected time of the sound volume decrease point in the shot start point buffer 3.

When the image is ended and the important shot determining unit 81 then receives an image end signal, the important shot determining unit 81 acquires the detected times of cut points from the shot start point buffer 3, and calculates the shot length of a shot starting from each of the cut points from the detected times, like that of above-mentioned Embodiment 9.

The important shot determining unit 81 then determines the start point and playback time duration of an important shot by determining, as a shot to be played back (an important shot), a shot having a long shot length on a priority basis from among a plurality of shots according to a desired digest watching time.

Because the concrete description of processing carried out by the important shot determining unit 81 is the same as that of above-mentioned Embodiment 9, the detailed explanation of the processing will be omitted.

The image digesting apparatus according to this Embodiment 16 makes it possible for the user to watch and listen to only important shots by discriminating shots on the basis of the sound volume. The unnaturalness at a time of watching and listening to important shots continuously can be reduced by using portions with a small sound volume.

The image digesting apparatus according to this Embodiment 16 can be applied not to an image content, but to a content including only sounds, such as a radio broadcast program.

As time information, such as a shot length and a shot start point, a time, a frame number, time information in image compressed data, or the like can be used.

### Embodiment 17

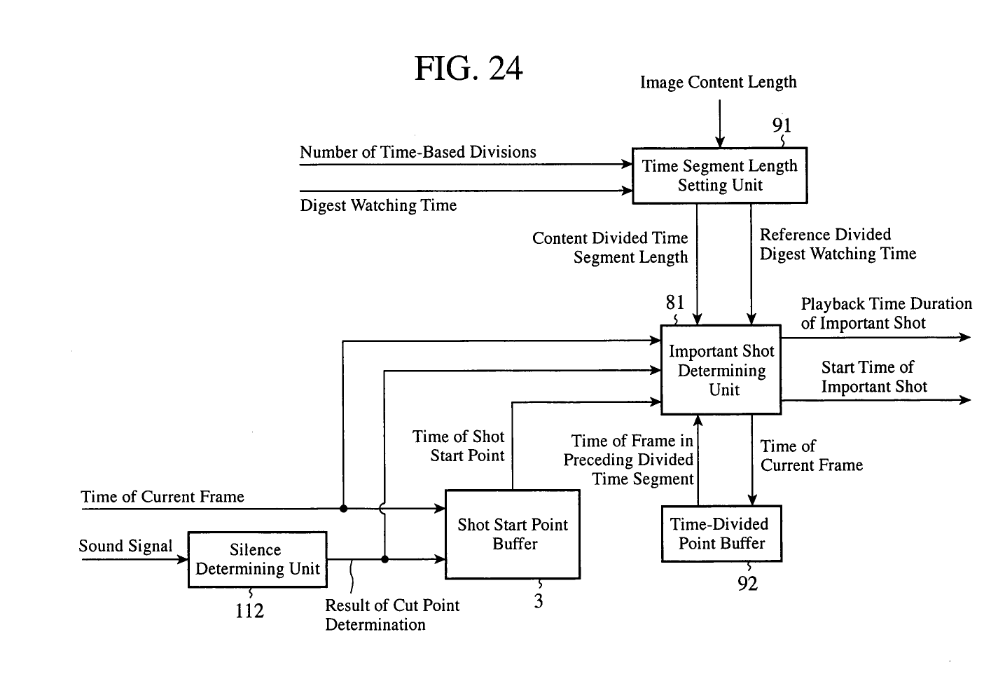

FIG. 24 is a block diagram showing an image digesting apparatus in accordance with Embodiment 17 of the present invention. In the figure, because the same reference numerals as those shown in FIGS. 15 and 21 denote the same components or like components, the explanation of these components will be omitted hereafter.

Next, the operation of the image digesting apparatus will be explained.

When receiving a digest watching time T_{Dijest}, the number n of time-based divisions of an image content, and an image content length T_{Content} which have been set up by a user, the time segment length setting unit 91 sets up the content divided time segment length T_{Segment} and the reference divided digest watching time T_{S}_{_{—}}_{Dijest} according to those pieces of input information, like that of above-mentioned Embodiment 10.

T_{Segment}=T_{Content}/n

T_{S}_{_{—}}_{Dijest}=T_{Dijest}/n

For example, in a case in which the image content length T_{Content} is 30 minutes (=1,800 seconds), the digest watching time T_{Dijest} is 5 minutes (=300 seconds), and the number n of time-based divisions of the image content is 10, the content divided time segment length T_{Segment} is set to 3 minutes (=180 seconds) and the reference divided digest watching time T_{S}_{_{—}}_{Dijest} is set to 0.5 minutes (=30 seconds).

When inputting a sound signal in an image, the sound volume determining unit 112 compares the sound volume of the sound signal with a preset threshold so as to detect a sound volume decrease point whose sound volume of the sound signal is smaller than the threshold, like that of above-mentioned Embodiment 14.

The sound volume determining unit 112 does not assume that any point at which the sound volume of the sound signal is larger than the threshold is a cut point, but assumes that a sound volume decrease point whose sound volume of the sound signal is smaller than the threshold is a cut point, and outputs the result of the detection to both the shot start point buffer 3 and the important shot determining unit 81 as the result of the cut point determination. Furthermore, when detecting a sound volume decrease point, the sound volume determining unit stores the detected time of the sound volume decrease point in the shot start point buffer 3.

When receiving the result of the cut point determination from the sound volume determining unit 112, the important shot determining unit 81 calculates the shot length of a shot starting from each cut point from the detected time of each cut point stored in the shot start point buffer 3 at a time defined by a time segment length set up by the time segment length setting unit 91, and determines, as a shot to be played back, a shot having a long shot length on a priority basis from among a plurality of shots according to a desired digest watching time, like that of above-mentioned Embodiment 10.

Because the concrete description of processing carried out by the important shot determining unit 81 is the same as that of above-mentioned Embodiment 10, the detailed explanation of the processing will be omitted hereafter.

In the case of above-mentioned Embodiment 16, the amount of computations required to sort the shot lengths of the whole content may become huge when the content is very long. In contrast, in accordance with this Embodiment 17, because the sorting of the shot lengths has only to be carried out only for the i-th segment, even when the content is very long, the amount of computations required to sort the shot lengths can be prevented from becoming huge and therefore the user is enabled to watch and listen to only important shots.

The unnaturalness at a time of watching and listening to important shots continuously can be reduced by using portions with a small sound volume.

The image digesting apparatus according to this Embodiment 17 can be applied not to an image content, but to a content including only sounds, such as a radio broadcast program.

As time information, such as a shot length and a shot start point, a time, a frame number, time information in image compressed data, or the like can be used.

### Embodiment 18

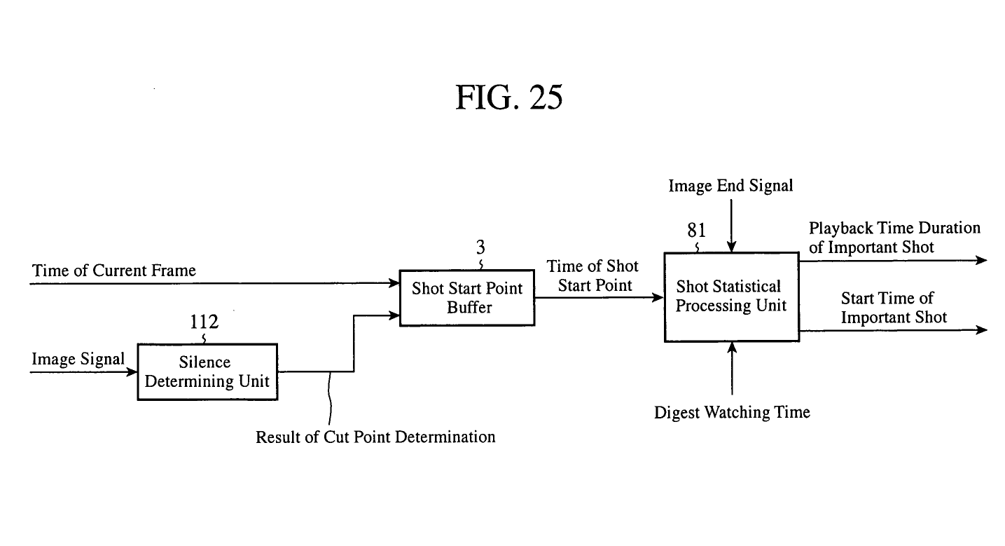

FIG. 25 is a block diagram showing an image digesting apparatus in accordance with Embodiment 18 of the present invention. In the figure, because the same reference numerals as those shown in FIGS. 16 and 21 denote the same components or like components, the explanation of these components will be omitted hereafter.

Next, the operation of the image digesting apparatus will be explained.

When inputting a sound signal in an image, the sound volume determining unit 112 compares the sound volume of the sound signal with a preset threshold so as to detect a sound volume decrease point whose sound volume of the sound signal is smaller than the threshold, like that of above-mentioned Embodiment 14.

The sound volume determining unit 112 does not assume that any point at which the sound volume of the sound signal is larger than the threshold is a cut point, but assumes that a sound volume decrease point whose sound volume of the sound signal is smaller than the threshold is a cut point, and outputs the result of the detection to the shot start point buffer 3 as the result of the cut point determination. Furthermore, when detecting a sound volume decrease point, the sound volume determining unit stores the detected time of the sound volume decrease point in the shot start point buffer 3.

When the image is ended and then receiving an image end signal, the shot statistical processing unit 101 acquires the detected time of each cut point (the detected time of each sound volume decrease point) from the shot start point buffer 3, calculates the shot length of a shot starting from each cut point from the detected time, and acquires a statistical distribution function about the shot length, like that of above-mentioned Embodiment 11.

The shot statistical processing unit 101 then determines a shot to be played back (an important shot) from among a plurality of shots according to a desired digest watching time and on the basis of the above-mentioned distribution function so as to determine the start point and playback time duration of the important shot.

Because the concrete description of processing carried out by the shot statistical processing unit 101 is the same as that of above-mentioned Embodiment 14, the detailed explanation of the processing will be omitted hereafter.

The image digesting apparatus according to this Embodiment 18 makes it possible to change the accuracy of the statistical processing according to the capability of a computer to be used. Also in a case in which the present embodiment is applied to mobile equipment or the like, the user is enabled to watch and listen to only important shots. The unnaturalness at a time of watching and listening to important shots continuously can be reduced by using portions with a small sound volume.

The image digesting apparatus according to this Embodiment 13 can be applied not to an image content, but to a content including only sounds, such as a radio broadcast program.

As time information, such as a shot length and a shot start point, a time, a frame number, time information in image compressed data, or the like can be used.

### Embodiment 19

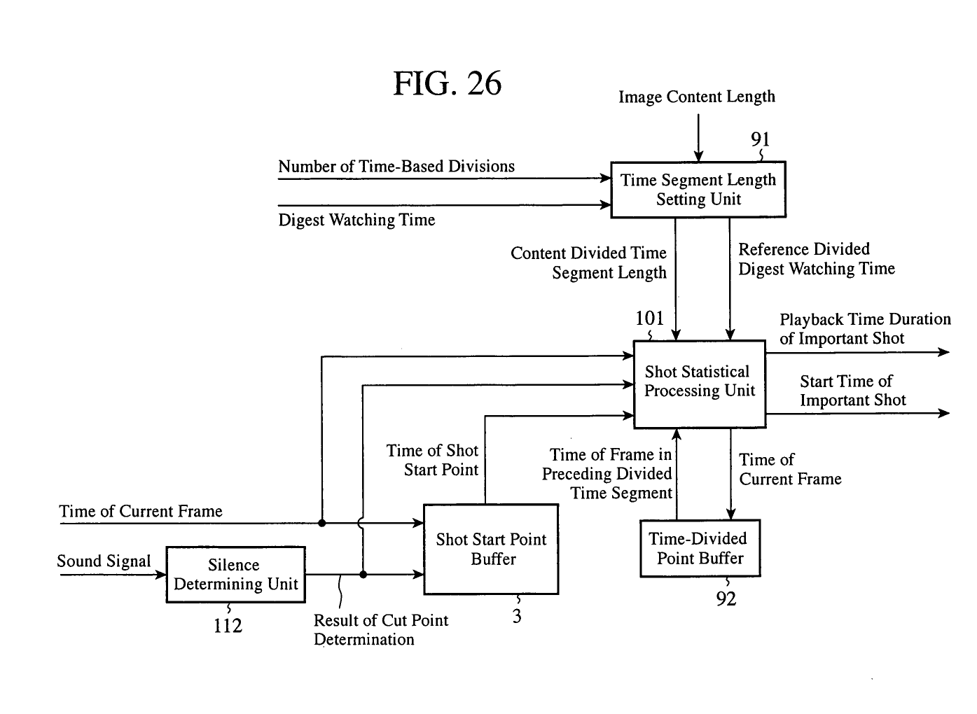

FIG. 26 is a block diagram showing an image digesting apparatus in accordance with Embodiment 19 of the present invention. In the figure, because the same reference numerals as those shown in FIGS. 19 and 21 denote the same components or like components, the explanation of these components will be omitted hereafter.

Next, the operation of the image digesting apparatus will be explained.

When receiving a digest watching time T_{Dijest}, the number n of time-based divisions of an image content, and an image content length T_{Content} which have been set up by a user, the time segment length setting unit 91 sets up the content divided time segment length T_{Segment} and the reference divided digest watching time T_{S}_{_{—}}_{Dijest} according to those pieces of input information, like that of above-mentioned Embodiment 12.

T_{Segment}=T_{Content}/n

T_{S}_{_{—}}_{Dijest}=T_{Dijest}/n

For example, in a case in which the image content length T_{Content} is 30 minutes (=1,800 seconds), the digest watching time T_{Dijest} is 5 minutes (=300 seconds), and the number n of time-based divisions of the image content is 10, the content divided time segment length T_{Segment} is set to 3 minutes (=180 seconds) and the reference divided digest watching time T_{S}_{_{—}}_{Dijest} is set to 0.5 minutes (=30 seconds).

When inputting a sound signal in an image, the sound volume determining unit 112 compares the sound volume of the sound signal with a preset threshold, and detects a sound volume decrease point whose sound volume of the sound signal is smaller than the threshold, like that of above-mentioned Embodiment 14.

The sound volume determining unit 112 does not assume that any point at which the sound volume of the sound signal is larger than the threshold is a cut point, but assumes that a sound volume decrease point whose sound volume of the sound signal is smaller than the threshold is a cut point, and outputs the result of the detection to both the shot start point buffer 3 and the shot statistical processing unit 101 as the result of the cut point determination. Furthermore, when detecting a sound volume decrease point, the sound volume determining unit stores the detected time of the sound volume decrease point in the shot start point buffer 3.

When the image is ended and then receiving an image end signal, the shot statistical work unit 101 acquires the detected time of each cut point (the detected time of each sound volume decrease point) from the shot start point buffer 3 at a time defined by a time segment length set up by the time segment length setting unit 91, calculates the shot length of a shot starting from each cut point from the detected time, and acquires a statistical distribution function about the shot length, like that of above-mentioned Embodiment 12.

The shot statistical processing unit 101 then determines a shot to be played back (an important shot) from among a plurality of shots according to a desired digest watching time and on the basis of the distribution function so as to determine the start point and playback time duration of the important shot.

Because the concrete description of processing carried out by the shot statistical processing unit 101 is the same as that of above-mentioned Embodiment 12, the detailed explanation of the processing will be omitted hereafter.

Even in a case in which this Embodiment 19 is applied to a computer having poor throughput, such as mobile equipment, and a very long content is processed by the computer, by adjusting the accuracy of the dividing processing and that of the statistical processing, the user is enabled to watch and listen to only important shots.

The unnaturalness at a time of watching and listening to important shots continuously can be reduced by using portions with a small sound volume.

The image digesting apparatus according to this Embodiment 19 can be applied not to an image content, but to a content including only sounds, such as a radio broadcast program.

As time information, such as a shot length and a shot start point, a time, a frame number, time information in image compressed data, or the like can be used.

### Embodiment 20

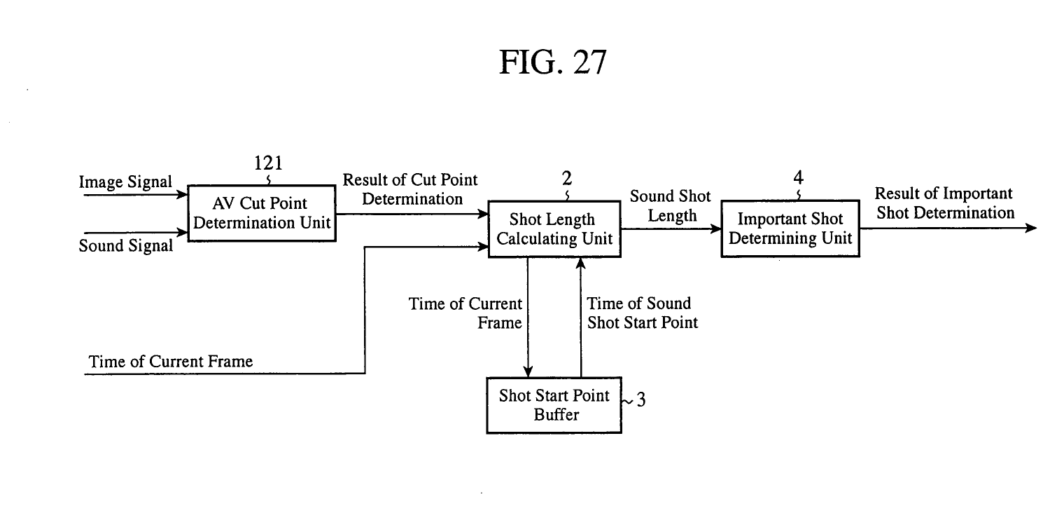

FIG. 27 is a block diagram showing an image digesting apparatus in accordance with Embodiment 20 of the present invention. In the figure, because the same reference numerals as those shown in FIG. 1 denote the same components or like components, the explanation of these components will be omitted hereafter.

An AV cut point determination unit 121 is provided with a cut point detecting part 1 and a sound volume determining part 112, and carries out a process of finally determining a cut point from both a determination result of the cut point detecting part 1 and a determination result of the sound volume determining part 112.

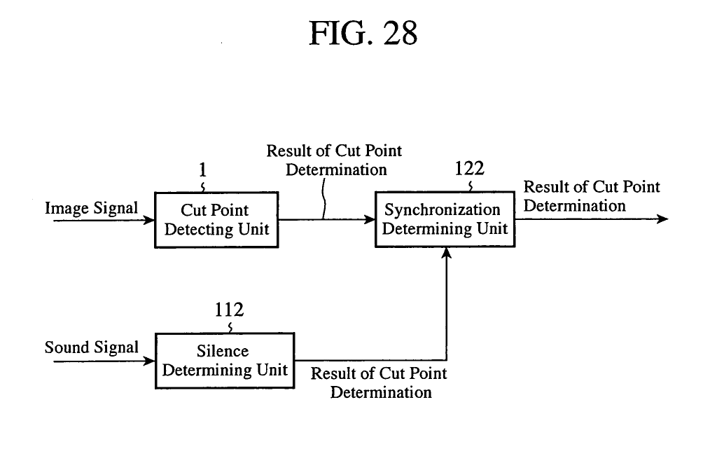

FIG. 28 is a block diagram showing the AV cut point determination unit 121 of the image digesting apparatus in accordance with Embodiment 20 of the present invention. In the figure, a synchronization determining part 122 carries out a process of performing final determination of whether or not a current frame is a cut point when the determination result outputted from the cut point detecting part 1 shows that the current frame is a cut point, and the determination result outputted from the sound volume determining part 112 also shows that the current frame is a cut point.

Next, the operation of the image digesting apparatus will be explained.

When receiving an image signal, the cut point detecting part 1 of the AV cut point determination unit 121 detects a cut point of the image, like that of above-mentioned Embodiment 1. As an alternative, a method of detecting a cut point different from that of above-mentioned Embodiment 1 can be used.

When inputting a sound signal in an image, the sound volume determining part 112 of the AV cut point determination unit 121 compares the sound volume of the sound signal with a preset threshold so as to detect a sound volume decrease point whose sound volume of the sound signal is smaller than the threshold, like that of above-mentioned Embodiment 14.

The sound volume determining part 112 does not assume that any point at which the sound volume of the sound signal is larger than the threshold is a cut point, but assumes that a sound volume decrease point whose sound volume of the sound signal is smaller than the threshold is a cut point, and outputs the result of the detection as the result of the cut point determination.

When the determination result outputted from the cut point detecting unit 1 shows that the current frame is a cut point, and the determination result outputted from the sound volume determining unit 112 also shows that the current frame is a cut point, the synchronization determining part 122 of the AV cut point determination unit 121 performs final determination of whether or not the current frame is a cut point.

More specifically, when both the cut point detecting part 1 and the sound volume determining part 112 detect a cut point at the same time, the synchronization determining part 122 assumes that the cut point is a cut point in the image content, whereas when either of the cut point detecting part 1 and the sound volume determining part 112 detects a cut point and the other one of them does not detect the cut point, the synchronization determining part does not assume that the cut point is a cut point in the image content.

When the result of the cut point determination outputted from the AV cut point determination unit 121 shows that the current frame is not a cut point, the shot length calculating unit 2 does not carry out any processing especially, whereas when the result of the cut point determination outputted from the AV cut point determination unit shows that the current frame is a cut point, the shot length calculating unit 2 calculates the time difference between the time of the current frame and the time of the shot start point of an immediately preceding shot stored in the shot start point buffer 3 and outputs, as the shot length, the time difference to the important shot determining unit 4, like that of above-mentioned Embodiment 1.

The shot length calculating unit 2 replaces the memory content of the shot start point buffer 3 with the time of the current frame after calculating the shot length.

After the shot length calculating unit 2 calculates the shot length, the important shot determining unit 4 compares the shot length with a preset threshold A, like that of above-mentioned Embodiment 1.

When the shot length is longer than the preset threshold A, the important shot determining unit 4 then determines that a shot starting from a silent point (a cut point) immediately preceding the silent point (the cut point) currently detected by the AV cut point determination unit 121 is an important shot, and outputs the result of the determination.

In this case, the important shot determining unit 4 determines that the shot starting from the immediately preceding cut point is an important shot. As an alternative, the important shot determining unit can determine that a next shot next to the shot starting from the immediately preceding cut point is an important shot, or can determine that both the shot starting from the immediately preceding cut point and the next shot are important shots.

The image digesting apparatus according to this Embodiment 20 enables the user to watch and listen to only important shots by determining a cut point using both the image and the sound volume and then acquiring a long shot.

Furthermore, the unnaturalness at a time of watching and listening to important shots continuously can be reduced by using portions with a small sound volume.

In addition, as time information, such as a shot length and a shot start point, a time, a frame number, time information in image compressed data, or the like can be used.

### Embodiment 10

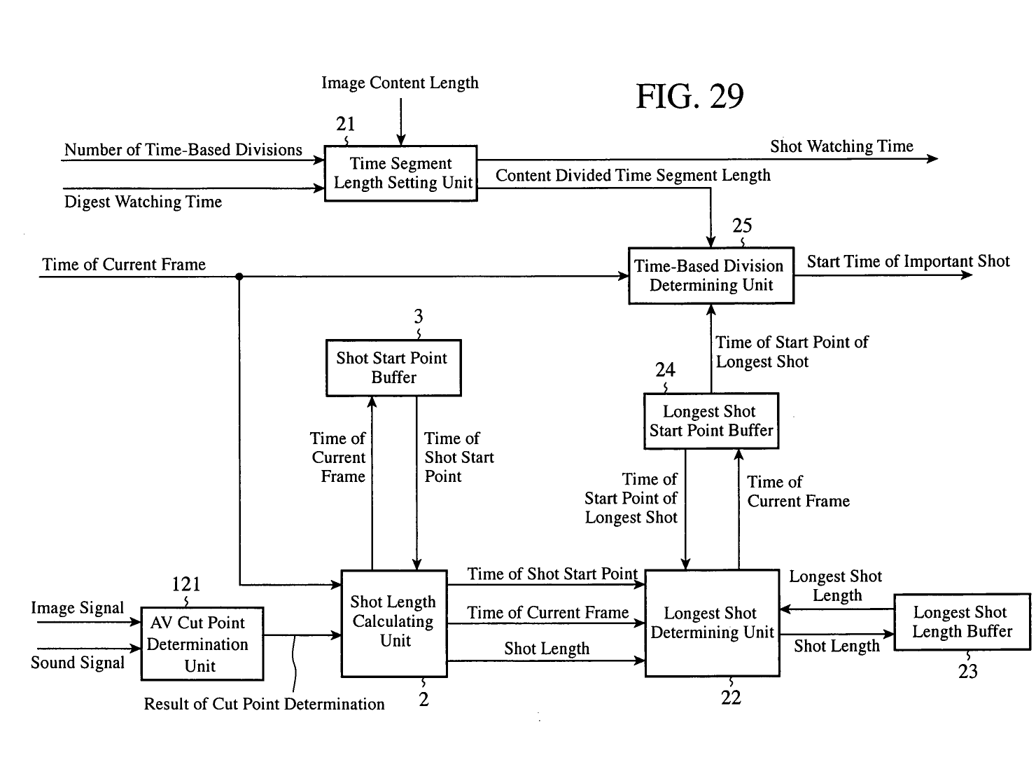

FIG. 29 is a block diagram showing an image digesting apparatus in accordance with Embodiment 21 of the present invention. In the figure, because the same reference numerals as those shown in FIGS. 5 and 27 denote the same components or like components, the explanation of these components will be omitted hereafter.

Next, the operation of the image digesting apparatus will be explained.

When receiving a digest watching time T_{Dijest}, the number n of time-based divisions of an image content, and an image content length T_{Content} which have been set up by a user, the time segment length setting unit 21 sets up the number Nₛₕₒₜ of important shots to be extracted, the content divided time segment length T_{segment}, and the shot watching time T_{Play} according to those pieces of input information, like that of above-mentioned Embodiment 2.

Nₛₕₒₜ=n

T_{Segment}=T_{Content}/n

T_{Play}=T_{Dijest}/n

In the case in which the time segment length setting unit sets up the parameters in this way, the user will watch and listen to only a T_{Play}-second head part of each of n shots.

For example, in a case in which the image content length T_{Content} is 30 minutes (=1,800 seconds), the digest watching time T_{Dijest} is 5 minutes (=300 seconds), and the number n of time-based divisions of the image content is 10, the content divided time segment length T_{Segment} is set to 3 minutes (=180 seconds) and the shot watching time T_{Play} is set to 0.5 minutes (=30 seconds).

As an alternative, the time segment length setting unit 21 can input, instead of the numerical information, information expressed in words, and analyze the words so as to determine the digest watching time T_{Dijest}, the number n of time-based divisions of the image content, and the image content length T_{content}.

The AV cut point determination unit 121 finally determines whether or not the current frame is a cut point from both the determination result of the cut point detecting part 1 and the determination result of sound volume determining part 112, like that of above-mentioned Embodiment 20.

When the result of the cut point determination outputted from the AV cut point determination unit 121 shows that the current frame is not a cut point, the shot length calculating unit 2 does not carry out any processing especially, whereas when the result of the cut point determination outputted from the AV cut point determination unit shows that the frame is a cut point, the shot length calculating unit 2 calculates the time difference between the time of the current frame and the time of the shot start point of an immediately preceding shot stored in the shot start point buffer 3 and outputs, as the shot length, the time difference to the important shot determining unit 4, like that of above-mentioned Embodiment 1.

The shot length calculating unit 2 replaces the memory content of the shot start point buffer 3 with the time of the current frame after calculating the shot length.

Every time when the shot length calculating unit 2 calculates a shot length, the longest shot determining unit 22 compares shot lengths which have been calculated by the shot length calculating unit 2 with one another so as to determine a shot having the longest shot length, like that of above-mentioned Embodiment 2.

More specifically, after the shot length calculating unit 2 calculates a shot length, the longest shot determining unit 22 compares the shot length currently calculated by the shot length calculating unit 2 with the shot length of the longest shot stored in the longest shot length buffer 23, and, when the shot length currently calculated by the shot length calculating unit 2 is longer than the shot length of the longest shot stored in the longest shot length buffer 23, determines that the shot whose shot length is currently calculated by the shot length calculating unit 2 is the longest shot at present.

After determining the longest shot at present, the longest shot determining unit 22 replaces the memory content of the longest shot length buffer 23 with the shot length currently calculated by the shot length calculating unit 2.

The longest shot determining unit 22 also replaces the memory content of the longest shot start point buffer 24 with the time of the start point of the longest shot (the time of the current frame).

The time-based division determining unit 25 outputs the time of the start point of the important shot at a time defined by the content divided time segment T_{Segment} set up by the time segment length setting unit 21, like that of above-mentioned Embodiment 2.

More specifically, when the time of the current frame is an integral multiple of the content divided time segment length T_{Segment} set up by the time segment length setting unit 21, the time-based division determining unit 25 carries out a process of outputting the start time of the longest shot stored in the longest shot start point buffer 24 as the start time of an important shot which is used for playback of a digest.

In this embodiment, the time-based division determining unit 25 outputs the time of the start point of the longest shot, as mentioned above. As an alternative, the time-based division determining unit can output either the time of the start point of a next shot next to the longest shot, or both the time of the start point of the longest shot and that of the next shot.

In this case, a buffer for storing the time of the start point of the next shot next to the longest shot needs to be disposed.

As can be seen from the above description, the image digesting apparatus in accordance with this embodiment 21 is so constructed as to compare shot lengths which have been calculated by the shot length calculating unit 2 with one another by discriminating shots on the basis of both the image and the sound volume every time when the shot length calculating unit 2 calculates a shot length, and to detect a shot having the longest shot length at a time defined by a time segment length set up by the time segment length setting unit 21. Therefore, the present embodiment offers an advantage of making it possible for the user to grasp important shots easily without causing any increase in the calculation load by carrying out a very complicated process, such as a process based on either one of a variety of image processing methods and sound processing methods.

In a case in which this Embodiment 21 is applied to a recording apparatus, a sound recording system, or a playback apparatus, because the start time and shot playback time duration of an important shot based on the image and the sound volume are known, automatic editing of the image and simple watching and listening of playback of a digest of the image can be implemented. Furthermore, the unnaturalness at a time of watching and listening to important shots continuously can be reduced by using portions with a small sound volume.

In addition, as time information, such as a shot length and a shot start point, a time, a frame number, time information in image compressed data, or the like can be used.

### Embodiment 22

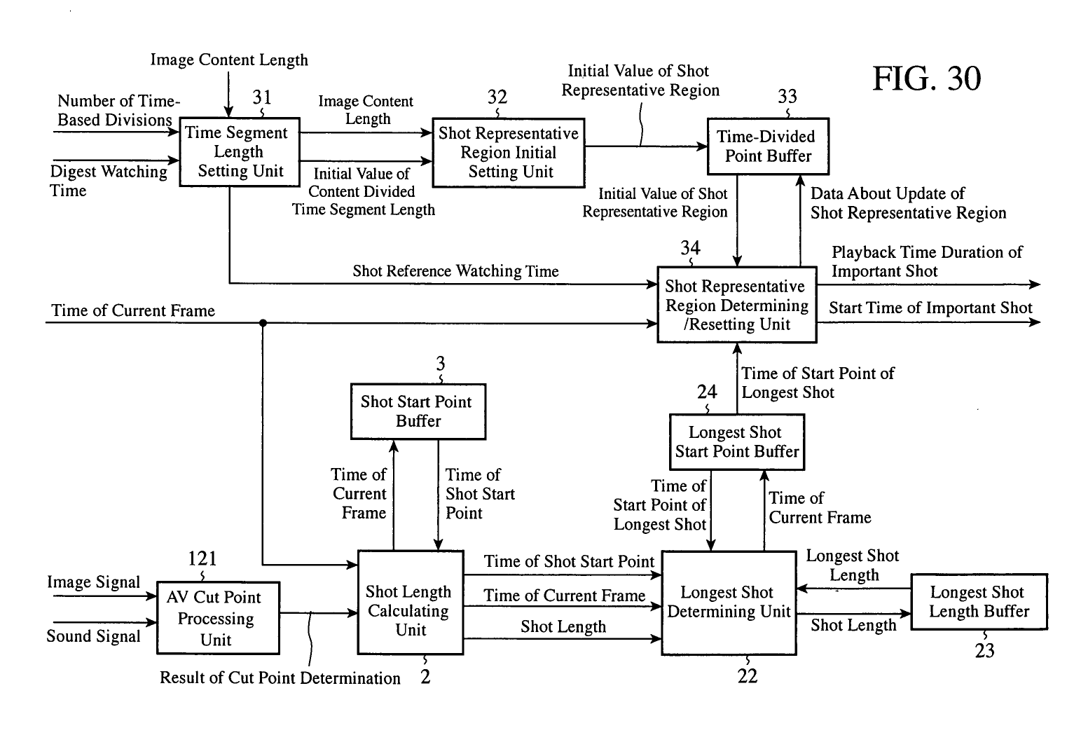

FIG. 30 is a block diagram showing an image digesting apparatus in accordance with Embodiment 22 of the present invention. In the figure, because the same reference numerals as those shown in FIGS. 6 and 27 denote the same components or like components, the explanation of these components will be omitted hereafter.

Next, the operation of the image digesting apparatus will be explained.

When receiving a digest watching time T_{Dijest}, the number n of time-based divisions of an image content, and an image content length T_{Content} which have been set up by a user, the time segment length setting unit 31 sets up the number Nₛₕₒₜ of important shots to be extracted, the initial value T_{Segment0} of the content divided time segment length, and the shot reference watching time T_{play0} according to those pieces of input information, like that of above-mentioned Embodiment 3.

Nₛₕₒₜ=n

T_{Segment0}=T_{Content}/n

T_{Play0}=T_{Dijest}/n

For example, in a case in which the image content length T_{Content} is 30 minutes (=1,800 seconds), the digest watching time T_{Dijest} is 5 minutes (=300 seconds), and the number n of time-based divisions of the image content is 10, the initial value T_{Segment0} of the content divided time segment length is set to 3 minutes (=180 seconds) and the shot reference watching time T_{play0} is set to 0.5 minutes (=30 seconds).

As an alternative, the time segment length setting unit 31 can input, instead of the numerical information, information expressed in words, and analyze the words so as to determine the digest watching time T_{Dijest}, the number n of time-based divisions of the image content, and the image content length T_{Content}.

After the time segment length setting unit 31 sets up the initial value T_{Segment0} of the content divided time segment length, the shot representative region initial setting unit 32 sets up an initial value of a shot representative region (the start point P_{Start} of the shot representative region and the end point P_{End}_{_{—}}ₜₑₘₚ of a temporary shot representative region) from the initial value T_{Segment0} of the content divided time segment length and the image content length T_{content}, like that of above-mentioned Embodiment 3.

P_{Start}=0

P_{End}_{_{—}}ₜₑₘₚ=T_{Content}/Nₛₕₒₜ=T_{Segment0}

After setting up the initial value of the shot representative region, the shot representative region initial setting unit 32 stores the initial value of the shot representative region in the time-divided point buffer 33.

The AV cut point determination unit 121 finally determines whether or not the frame is a cut point from both the determination result of the cut point detecting part 1 and the determination result of sound volume determining part 112, like that of above-mentioned Embodiment 20.

When the result of the cut point determination outputted from the AV cut point determination unit 121 shows that the current frame is not a cut point, the shot length calculating unit 2 does not carry out any processing especially, whereas when the result of the cut point determination outputted from the AV cut point determination unit shows that the current frame is a cut point, the shot length calculating unit 2 calculates the time difference between the time of the current frame and the time of the shot start point of an immediately preceding shot stored in the shot start point buffer 3 and outputs, as the shot length, the time difference to the important shot determining unit 4, like that of above-mentioned Embodiment 1.

The shot length calculating unit 2 replaces the memory content of the shot start point buffer 3 with the time of the current frame after calculating the shot length.

Every time when the shot length calculating unit 2 calculates a shot length, the longest shot determining unit 22 compares shot lengths which have been calculated by the shot length calculating unit 2 with one another so as to determine a shot having the longest shot length, like that of above-mentioned Embodiment 2.

More specifically, after the shot length calculating unit 2 calculates a shot length, the longest shot determining unit 22 compares the shot length currently calculated by the shot length calculating unit 2 with the shot length of the longest shot stored in the longest shot length buffer 23, and, when the shot length currently calculated by the shot length calculating unit 2 is longer than the shot length of the longest shot stored in the longest shot length buffer 23, determines that the shot whose shot length is currently calculated by the shot length calculating unit 2 is the longest shot at present.

After determining the longest shot at present, the longest shot determining unit 22 replaces the memory content of the longest shot length buffer 23 with the shot length currently calculated by the shot length calculating unit 2.

The longest shot determining unit 22 also replaces the memory content of the longest shot start point buffer 24 with the time of the start point of the longest shot (the time of the current frame).

When the time P_{Now} of the current frame exceeds the end point P_{End}_{_{—}}ₜₑₘₚ of the temporary shot representative region stored in the time-divided point buffer 33, the shot representative region determining/resetting unit 34 calculates the end point P_{End} of the shot representative region and the important shot playback time duration T_{Play} and outputs the important shot playback time duration T_{Play}, like that of above-mentioned Embodiment 3.

P_{End}=P_{Now}+P_{Shot}_{_{—}}_{Start}−P_{Start}

T_{Play}=(P_{End}−P_{Start})*T_{Play0}/T_{Segment0}

where P_{Shot}_{_{—}}ₛₜₐᵣₜ is the start time of the longest shot which is stored in the longest shot start point buffer 24.

Furthermore, when the time P_{Now} of the current frame exceeds the end point P_{End}_{_{—}}ₜₑₘₚ of the temporary shot representative region stored in the time-divided point buffer 33, the shot representative region determining/resetting unit 54 outputs the time P_{Shot}_{_{—}}ₛₜₐᵣₜ of the start point of the longest shot which is stored in the longest shot start point buffer 24 as the start time of an important shot which is used for playback of a digest, and updates both the start point P_{Start} of the shot representative region and the end point P_{End}_{_{—}}ₜₑₘₚ of the temporary shot representative region which are stored in the time-divided point buffer 33.

The updated shot representative region is given as follows.

P_{Start}=P_{End}

P_{End}_{_{—}}ₜₑₘₚ=P_{End}+T_{Content}/Nₛₕₒₜ=P_{End}+T_{Segment0}

As can be seen from the above description, because the image digesting apparatus in accordance with this embodiment 22 is so constructed as to update the shot representative region according to the start time of the longest shot determined by the longest shot determining unit 22 and the shot length by discriminating shots on the basis of the image and the sound volume, there is provided an advantage of making it possible to change breakpoints of the content and the playback time duration of an important shot in a divided part of the content adaptively. Furthermore, the unnaturalness at a time of watching and listening to important shots continuously can be reduced by using portions with a small sound volume.

In addition, as time information, such as a shot length and a shot start point, a time, a frame number, time information in image compressed data, or the like can be used.

### Embodiment 23

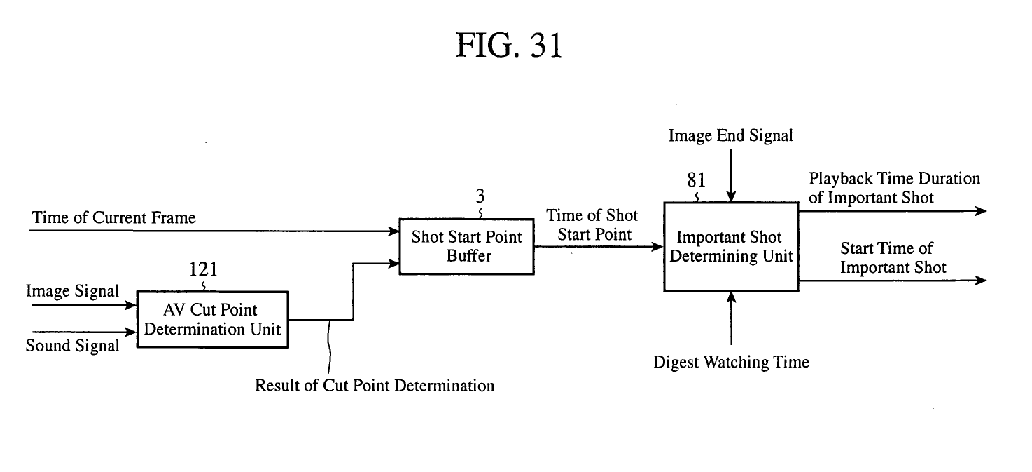

FIG. 31 is a block diagram showing an image digesting apparatus in accordance with Embodiment 23 of the present invention. In the figure, because the same reference numerals as those shown in FIGS. 14 and 27 denote the same components or like components, the explanation of these components will be omitted hereafter.

Next, the operation of the image digesting apparatus will be explained.

The AV cut point determination unit 121 finally determines whether or not a current frame is a cut point from both the determination result of the cut point detecting part 1 and the determination result of the sound volume determining part 112, like that of above-mentioned Embodiment 20.

When finally detecting a cut point, the AV cut point determination unit 121 stores the detected time of the cut point in the shot start point buffer 3.

When the image is ended and the important shot determining unit 81 then receives an image end signal, the important shot determining unit 81 acquires the detected times of cut points from the shot start point buffer 3, and calculates the shot length of a shot starting from each of the cut points from the detected times, like that of above-mentioned Embodiment 9.

The important shot determining unit 81 then determines the start point and playback time duration of an important shot by determining, as a shot to be played back (an important shot), a shot having a long shot length on a priority basis from among a plurality of shots according to a desired digest watching time.

Because the concrete description of processing carried out by the important shot determining unit 81 is the same as that of above-mentioned Embodiment 9, the detailed explanation of the processing will be omitted.

The image digesting apparatus according to this Embodiment 23 makes it possible for the user to watch and listen to only important shots by discriminating shots on the basis of the image and the sound volume. Furthermore, the unnaturalness at a time of watching and listening to important shots continuously can be reduced by using portions with a small sound volume.

In addition, as time information, such as a shot length and a shot start point, a time, a frame number, time information in image compressed data, or the like can be used.

### Embodiment 24

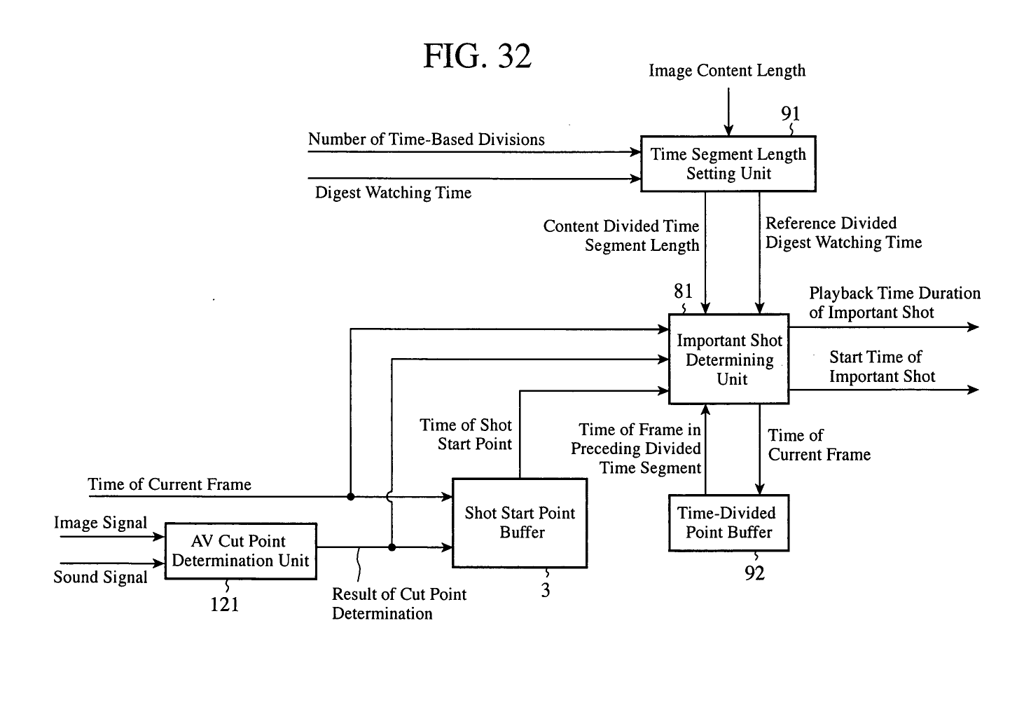

FIG. 32 is a block diagram showing an image digesting apparatus in accordance with Embodiment 24 of the present invention. In the figure, because the same reference numerals as those shown in FIGS. 15 and 27 denote the same components or like components, the explanation of these components will be omitted hereafter.

Next, the operation of the image digesting apparatus will be explained.

When receiving a digest watching time T_{Dijest}, the number n of time-based divisions of an image content, and an image content length T_{Content} which have been set up by a user, the time segment length setting unit 91 sets up the content divided time segment length T_{Segment} and the reference divided digest watching time T_{S}_{_{—}}_{Dijest} according to those pieces of input information, like that of above-mentioned Embodiment 10.

T_{Segment}=T_{Content}/n

T_{S}_{_{—}}_{Dijest}=T_{Dijest}/n

For example, in a case in which the image content length T_{Content} is 30 minutes (=1,800 seconds), the digest watching time T_{Dijest} is 5 minutes (=300 seconds), and the number n of time-based divisions of the image content is 10, the content divided time segment length T_{Segment} is set to 3 minutes (=180 seconds) and the reference divided digest watching time T_{S}_{_{—}}_{Dijest} is set to 0.5 minutes (=30 seconds).

The AV cut point determination unit 121 finally determines whether or not a current frame is a cut point from both the determination result of the cut point detecting part 1 and the determination result of the sound volume determining part 112 and outputs the determination result to the shot start point buffer 3 and the important shot determination unit 81, like that of above-mentioned Embodiment 20.

When finally detecting a cut point, the AV cut point determination part 121 stores the detected time of the cut point in the shot start point buffer 3.

When receiving the result of the cut point determination from the sound volume determining part 112, the important shot determining unit 81 calculates the shot length of a shot starting from each cut point from the detected time of each cut point stored in the shot start point buffer 3 at a time defined by a time segment length set up by the time segment length setting unit 91, and determines, as a shot to be played back, a shot having a long shot length on a priority basis from among a plurality of shots according to a desired digest watching time, like that of above-mentioned Embodiment 10.

Because the concrete description of processing carried out by the important shot determining unit 81 is the same as that of above-mentioned Embodiment 10, the detailed explanation of the processing will be omitted hereafter.

In the case of above-mentioned Embodiment 23, the amount of computations required to sort the shot lengths of the whole content may become huge when the content is very long. In contrast, in accordance with this Embodiment 24, because the sorting of the shot lengths has only to be carried out only for the i-th segment, even when the content is very long, the amount of computations required to sort the shot lengths can be prevented from becoming huge and therefore the user is enabled to watch and listen to only important shots based on the image and the sound volume.

Furthermore, the unnaturalness at a time of watching and listening to important shots continuously can be reduced by using portions with a small sound volume.

In addition, as time information, such as a shot length and a shot start point, a time, a frame number, time information in image compressed data, or the like can be used.

### Embodiment 25

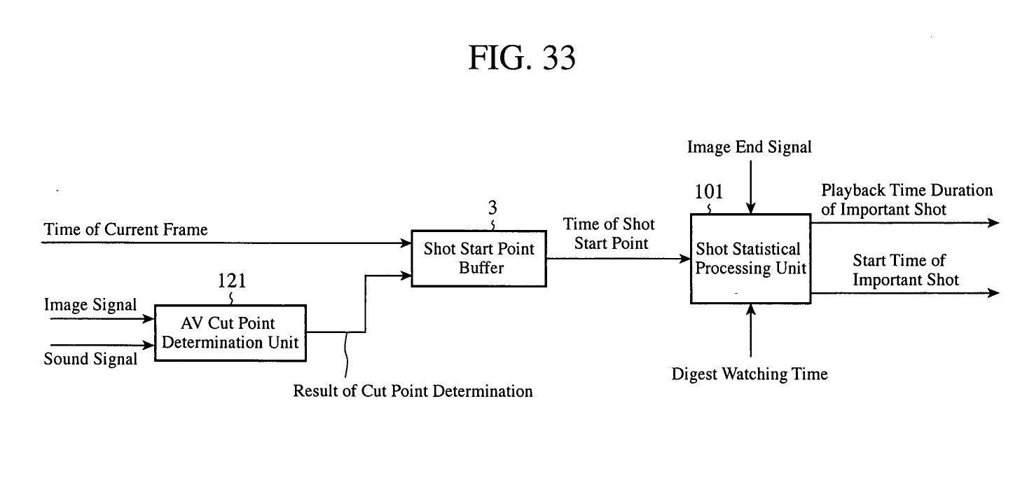

FIG. 33 is a block diagram showing an image digesting apparatus in accordance with Embodiment 25 of the present invention. In the figure, because the same reference numerals as those shown in FIGS. 16 and 27 denote the same components or like components, the explanation of these components will be omitted hereafter.

Next, the operation of the image digesting apparatus will be explained.

The AV cut point determination unit 121 finally determines whether or not a current frame is a cut point from both the determination result of the cut point detecting part 1 and the determination result of the sound volume determining part 112, like that of above-mentioned Embodiment 20.

When finally detecting a cut point, the AV cut point determination unit 121 stores the detected time of the cut point in the shot start point buffer 3.

When the image is ended and then receiving an image end signal, the shot statistical processing unit 101 acquires the detected time of each cut point (the detected time of each sound volume decrease point) from the shot start point buffer 3, calculates the shot length of a shot starting from each cut point from the detected time, and acquires a statistical distribution function about the shot length, like that of above-mentioned Embodiment 11.

The shot statistical processing unit 101 then determines a shot to be played back (an important shot) from among a plurality of shots according to a desired digest watching time and on the basis of the distribution function so as to determine the start point and playback time duration of the important shot.

Because the concrete description of processing carried out by the shot statistical processing unit 101 is the same as that of above-mentioned Embodiment 14, the detailed explanation of the processing will be omitted hereafter.

The image digesting apparatus according to this Embodiment 25 makes it possible to change the accuracy of the statistical processing according to the capability of a computer to be used. Also in a case in which the present embodiment is applied to mobile equipment or the like, the user is enabled to watch and listen to only important shots based on the image and the sound volume. Furthermore, the unnaturalness at a time of watching and listening to important shots continuously can be reduced by using portions with a small sound volume.

In addition, as time information, such as a shot length and a shot start point, a time, a frame number, time information in image compressed data, or the like can be used.

### Embodiment 26

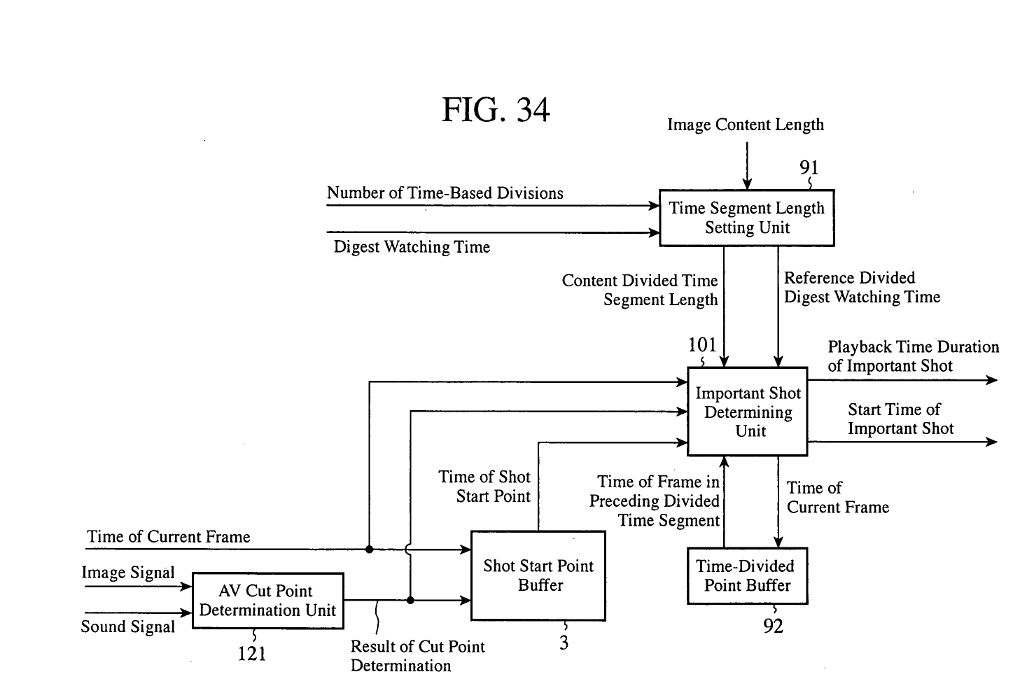

FIG. 34 is a block diagram showing an image digesting apparatus in accordance with Embodiment 26 of the present invention. In the figure, because the same reference numerals as those shown in FIGS. 19 and 27 denote the same components or like components, the explanation of these components will be omitted hereafter.

Next, the operation of the image digesting apparatus will be explained.

When receiving a digest watching time T_{Dijest}, the number n of time-based divisions of an image content, and an image content length T_{Content} which have been set up by a user, the time segment length setting unit 91 sets up the content divided time segment length T_{Segment} and the reference divided digest watching time T_{S}_{_{—}}_{Dijest} according to those pieces of input information, like that of above-mentioned Embodiment 10.

T_{Segment}=T_{Content}/n

T_{S}_{_{—}}_{Dijest}=T_{Dijest}/n

For example, in a case in which the image content length T_{Content} is 30 minutes (=1,800 seconds), the digest watching time T_{Dijest} is 5 minutes (=300 seconds), and the number n of time-based divisions of the image content is 10, the content divided time segment length T_{Segment} is set to 3 minutes (=180 seconds) and the reference divided digest watching time T_{S}_{_{—}}_{Dijest} is set to 0.5 minutes (=30 seconds).

The AV cut point determination unit 121 finally determines whether or not a current frame is a cut point from both the determination result of the cut point detecting part 1 and the determination result of the sound volume determining part 112, like that of above-mentioned Embodiment 20, and outputs the determination result to both the shot start point buffer 3 and the shot statistical processing unit 101.

When finally detecting a cut point, the AV cut point determination unit 121 stores the detected time of the cut point in the shot start point buffer 3.

When the image is ended and then receiving an image end signal, the shot statistical processing unit 101 acquires the detected time of each cut point (the detected time of each sound volume decrease point) from the shot start point buffer 3 at a time defined by a time segment length set up by the time segment length setting unit 91, calculates the shot length of a shot starting from each cut point from the detected time, and acquires a statistical distribution function about the shot length, like that of above-mentioned Embodiment 12.

The shot statistical processing unit 101 then determines a shot to be played back (an important shot) from among a plurality of shots according to a desired digest watching time and on the basis of the distribution function so as to determine the start point and playback time duration of the important shot.

Because the concrete description of processing carried out by the shot statistical processing unit 101 is the same as that of above-mentioned Embodiment 12, the detailed explanation of the processing will be omitted hereafter.

Even in a case in which this Embodiment 26 is applied to a computer having poor throughput, such as mobile equipment, and a very long content is processed by the computer, by adjusting the accuracy of the dividing processing and that of the statistical processing, the user is enabled to watch and listen to only important shots based on the image and the sound volume.

Furthermore, the unnaturalness at a time of watching and listening to important shots continuously can be reduced by using portions with a small sound volume.

In addition, as time information, such as a shot length and a shot start point, a time, a frame number, time information in image compressed data, or the like can be used.

### INDUSTRIAL APPLICABILITY

As mentioned above, the image digesting apparatus in accordance with the present invention is suitable for applications which need to extract an image in an important section from an image signal in order for the user to be able to grasp important shots easily.

1. An image digesting apparatus comprising:
a cut point detecting means for detecting a cut point of an image;
a shot length calculating means for, when a cut point is detected by said cut point detecting means, calculating a shot length of a shot starting from a cut point immediately preceding said cut point; and
an important shot determining means for determining whether or not the shot starting from the cut point immediately preceding the cut point detected by said cut point detecting means is an important shot by using, as a criterion of the determination, the shot length calculated by said shot length calculating means.

2. The image digesting apparatus according to claim 1, characterized in that when the shot length calculated by the shot length calculating means is longer than a preset shot length, the important shot determining means determines that the shot starting from the cut point immediately preceding the cut point detected by said cut point detecting means is an important shot, determines that a next shot next to the shot starting from the immediately preceding cut point is an important shot, or determines that both the shot starting from the immediately preceding cut point and the next shot are important shots.

3. An image digesting apparatus comprising:
a cut point detecting means for detecting a cut point of an image; a shot length calculating means for, when a cut point is detected by said cut point detecting means, calculating a shot length of a shot starting from a cut point immediately preceding said cut point;
a time segment length setting means for setting up a time segment length with which the image is to be divided into parts; and
a longest shot detecting means for comparing shot lengths which have been calculated by said shot length calculating means with one another every time when said shot length calculating means calculates a shot length so as to detect a shot having a longest shot length, a shot having a second longest shot length, or both the shot having the longest shot length and the shot having the second longest shot length at a time defined by the time segment length set up by said time segment length setting means.

4. The image digesting apparatus according to claim 3, characterized in that the time segment length setting means updates the time segment length according to both a start time of the shot having the longest shot time which is detected by the longest shot detecting means, and the shot length.

5. An image digesting apparatus comprising:
a feature extracting means for extracting a feature indicating a feature of an image from an image signal;
a distance calculating means for calculating a distance between features from a feature currently extracted by said feature extracting means and a feature which was extracted last time by said feature extracting means;
a maximum distance detecting means for comparing distances between features which have been calculated by said distance calculating means with one another every time when said distance calculating means calculates a distance between features so as to detect a maximum distance; and
an important frame detection means for, when said maximum distance detecting means detects the maximum distance, if a time difference between a time of a frame at a time when a maximum distance was detected last time by said maximum distance detecting means and a time of a current frame is larger than a preset time difference, outputting the time of the current frame as a start time of an important frame.

6. An image digesting apparatus comprising:
a time segment length setting means for setting up a time segment length with an image is to be divided into parts; a cut point detecting means for detecting a cut point of the image;
a feature extracting means for extracting a feature indicating a feature of the image from an image signal;
a distance calculating means for calculating a distance between features from a feature currently extracted by said feature extracting means and a feature which was extracted last time by said feature extracting means;
a maximum distance detecting means for, in a case in which a cut point is detected by said cut point detecting means, comparing distances between features which have been calculated by said distance calculating means with one another every time when said distance calculating means calculates a distance between features so as to detect a maximum distance; and
an important shot detecting means for outputting, as a start time of an important shot, a time of a frame in which the maximum distance is detected by said maximum distance detecting means at a time defined by the time segment length set up by said time segment length setting means.

7. The image digesting apparatus according to claim 6, characterized in that the time segment length setting means updates the time segment length according to both the time of the frame in which the maximum distance is detected by the maximum distance detecting means, and the maximum distance.

8. An image digesting apparatus comprising:
a cut point detecting means for detecting a cut point of an image;
a feature extracting means for extracting a feature indicating a feature of the image from an image signal;
a distance calculating means for calculating a distance between features from a feature currently extracted by said feature extracting means and a feature which was extracted last time by said feature extracting means;
an average calculation means for calculating an average of distances between features which have been calculated by said distance calculating means every time when said distance calculating means calculates a distance between features;
a thumbnail candidate image storage means for storing the image of said image signal as a thumbnail candidate image when a difference between the distance between features calculated by said distance calculating means and the average calculated by said average calculation means is smaller than a preset minimum; and
a thumbnail creating means for creating a thumbnail from thumbnail candidate images stored in said thumbnail candidate image storage means when a cut point is detected by said cut point detecting means.

9. The image digesting apparatus according to claim 1, characterized in comprising: an important shot length storage means for storing the shot length of the important shot determined by the important shot determining means, and a playback time calculating means for calculating a playback time duration of the important shot from the shot length of the important shot stored in said important shot length storage means and a preset digest watching time.

10. The image digesting apparatus according to claim 1, characterized in that the cut point detecting means comprises: a feature extracting means for extracting a feature indicating a feature of the image from the image signal; a distance calculating means for calculating a distance between features from a feature currently extracted by said feature extracting means and a feature which was extracted last time by said feature extracting means; a threshold calculating means for calculating a statistics value of distances between features which have been calculated by said distance calculating means so as to calculate a threshold for determination of cut points from said statistics value; and a cut point determining means for comparing the distance between features calculated by said distance calculating means with the threshold calculated by said threshold calculating means so as to determine a cut point from a result of said comparison.

11. An image digesting apparatus comprising:
a cut point detecting means for detecting a cut point of an image;
a shot start point storage means for storing a time when a cut point is detected by said cut point detecting means; and
an important shot determining means for calculating a shot length of a shot starting from each cut point from a time stored in said shot start point storage means, and for determining, as a shot to be played back, a shot having a long shot length from among a plurality of shots on a priority basis according to a desired digest watching time.

12. An image digesting apparatus comprising:
a time segment length setting means for setting up a time segment length with which an image is to be divided into parts; a cut point detecting means for detecting a cut point of the image;
a shot start point storage means for storing a time when a cut point is detected by said cut point detecting means; and
an important shot determining means for calculating a shot length of a shot starting from each cut point from a time stored in said shot start point storage means at a time defined by the time segment length set up by said time segment length setting means, and for determining, as a shot to be played back, a shot having a long shot length from among a plurality of shots on a priority basis according to a desired digest watching time.

13. An image digesting apparatus comprising:
a cut point detecting means for detecting a cut point of an image;
a shot start point storage means for storing a time when a cut point is detected by said cut point detecting means; and
an important shot determining means for calculating a shot length of a shot starting from each cut point from a time stored in said shot start point storage means so as to acquire a statistical distribution function about said shot length, and for determining a shot to be played back from among a plurality of shots according to a desired digest watching time and on a basis of said distribution function.

14. An image digesting apparatus comprising:
a time segment length setting means for setting up a time segment length with which an image is to be divided into parts; a cut point detecting means for detecting a cut point of the image;
a shot start point storage means for storing a time when a cut point is detected by said cut point detecting means; and
an important shot determining means for calculating a shot length of a shot starting from each cut point from a time stored in said shot start point storage means at a time defined by the time segment length set up by said time segment length setting means so as to acquire a statistical distribution function about said shot length, and for determining a shot to be played back from among a plurality of shots according to a desired digest watching time and on a basis of said distribution function.

15. An image digesting apparatus comprising:
a silent point detecting means for detecting a silent point of a sound in an image;
a shot length calculating means for, when a silent point is detected by said silent point detecting means, calculating a shot length of a shot starting from a silent point immediately preceding said silent point; and
an important shot determining means for determining whether or not the shot starting from the silent point immediately preceding the silent point detected by said silent point detecting means is an important shot by using, as a criterion of the determination, the shot length calculated by said shot length calculating means.

16. An image digesting apparatus comprising:
a time segment length setting means for setting up a time segment length with which an image is to be divided into parts; a sound volume decrease point detecting means for detecting a sound volume decrease point at which a volume of a sound in the image is smaller than a threshold;
a shot length calculating means for, when a sound volume decrease point is detected by said sound volume decrease point detecting means, calculating a shot length of a shot starting from a sound volume decrease point immediately preceding said sound volume decrease point; and
a longest shot detecting means for comparing shot lengths which have been calculated by said shot length calculating means with one another every time when said shot length calculating means calculates a shot length so as to detect a shot having a longest shot length, a shot having a second longest shot length, or both the shot having the longest shot length and the shot having the second longest shot length at a time defined by the time segment length set up by said time segment length setting means.

17. The image digesting apparatus according to claim 16, characterized in that the time segment length setting means updates the time segment length according to both a start time of the shot having the longest shot time which is detected by the longest shot detecting means, and the shot length.

18. An image digesting apparatus comprising:
a sound volume decrease point detecting means for detecting a sound volume decrease point at which a volume of a sound in an image is smaller than a threshold;
a shot start point storage means for storing a time when a sound volume decrease point is detected by said sound volume decrease point detecting means;
an important shot determining means for calculating a shot length of a shot starting from each sound volume decrease point from a time stored in said shot start point storage means, and for determining, as a shot to be played back, a shot having a long shot length from among a plurality of shots on a priority basis according to a desired digest watching time.

19. An image digesting apparatus comprising:
a time segment length setting means for setting up a time segment length with which an image is to be divided into parts; a sound volume decrease point detecting means for detecting a sound volume decrease point at which a volume of a sound in an image is smaller than a threshold;
a shot start point storage means for storing a time when a sound volume decrease point is detected by said sound volume decrease point detecting means;
an important shot determining means for calculating a shot length of a shot starting from each sound volume decrease point from a time stored in said shot start point storage means at a time defined by the time segment length set up by said time segment length setting means, and for determining, as a shot to be played back, a shot having a long shot length from among a plurality of shots on a priority basis according to a desired digest watching time.

20. An image digesting apparatus comprising:
a sound volume decrease point detecting means for detecting a sound volume decrease point at which a volume of a sound in an image is smaller than a threshold;
a shot start point storage means for storing a time when a sound volume decrease point is detected by said sound volume decrease point detecting means;
an important shot determining means for calculating a shot length of a shot starting from each sound volume decrease point from a time stored in said shot start point storage means so as to acquire a statistical distribution function about said shot length, and for determining a shot to be played back from among a plurality of shots according to a desired digest watching time and on a basis of said distribution function.

21. An image digesting apparatus comprising:
a time segment length setting means for setting up a time segment length with which an image is to be divided into parts; a sound volume decrease point detecting means for detecting a sound volume decrease point at which a volume of a sound in an image is smaller than a threshold;
a shot start point storage means for storing a time when a sound volume decrease point is detected by said sound volume decrease point detecting means;
an important shot determining means for calculating a shot length of a shot starting from each sound volume decrease point from a time stored in said shot start point storage means at a time defined by the time segment length set up by said time segment length setting means so as to acquire a statistical distribution function about said shot length, and for determining a shot to be played back from among a plurality of shots according to a desired digest watching time and on a basis of said distribution function.

22. The image digesting apparatus according to claim 1, characterized in that when detecting a cut point of the image, the cut point detecting means detects a sound volume decrease point at which a volume of a sound in the image is smaller than a threshold, and detects a cut point which is synchronized with said sound volume decrease point from detected cut points.

23. The image digesting apparatus according to claim 11, characterized in that the important shot determining means determines, as a shot to be played back, a shot having a long shot length from among a plurality of shots on a priority basis.
